SEQUENCE LISTING (6 sequences)

SEQ ID NO: 1 - DNA, 52 bp, Homo sapiens
ggtaggggcagggaaagcatcagaatrtaagatgaaccaggagcatcttata

SEQ ID NO: 2 - DNA, 52 bp, Homo sapiens
ggcggtgatggttgctactttttatgsagggtttttgaaggcgtctctcata

SEQ ID NO: 3 - DNA, 52 bp, Homo sapiens
gttcaccagtaggggactggaaaaayaaagttacatccatacaataaagcac

SEQ ID NO: 4 - DNA, 52 bp, Homo sapiens
ggacccccaggatcgtcagggcctccyacagctggagtgggaagggagcaga

SEQ ID NO: 5 - DNA, 52 bp, Homo sapiens
tgagttaaaaagagaagaggtagtgsctggagaacgggaggcttgacgttga

SEQ ID NO: 6 - DNA, 52 bp, Homo sapiens
gtaacgaaagtttccactttttgcaasttaccatttatataaagtttaagac

(19) United States
(12) Patent Application Publication
(10) Pub. No.: US 2012/0309641 A1
(43) Pub. Date: Dec. 6, 2012

(54) DIAGNOSTIC KITS, GENETIC MARKERS, AND METHODS FOR SCD OR SCA THERAPY SELECTION

(75) Inventors: Orhan Soykan, Shoreview, MN (US); Tara Nahey, Minneapolis, MN (US); Jeffrey Lande, Minneapolis, MN (US)

(73) Assignee: MEDTRONIC, INC., Minneapolis, MN (US)

(21) Appl. No.: 13/515,498

(22) PCT Filed: Oct. 19, 2011
(86) PCT No.: PCT/US11/56964

§ 371 Date: Aug. 24, 2012

Related U.S. Application Data
(60) Provisional application No. 61/394,760, filed on Oct. 19, 2010.

(51) Int. Cl. C40B 30/04; G06F 19/18; C40B 40/06

(52) U.S. Cl. 506/9; 506/16; 702/19

(57) ABSTRACT

Variations in certain genomic sequences useful as genetic markers of Sudden Cardiac Death (“SCD”), or Sudden Cardiac Arrest (“SCA”) risk, are described. Novel diagnostic kits and methods employing these genetic markers are used in assessing the risk of SCD, or SCA. Methods of distinguishing patients having an increased susceptibility to SCD, or SCA, through use of these markers, alone or in combination with other markers, are also provided. Further, methods for assessing the need for an Implantable Cardio Defibrillator (“ICD”) in a patient with computer programmable processors and genetic databases are described.

### REFERENCE TO SEQUENCE LISTING

This application contains a Sequence Listing submitted as an electronic text file. The information contained in the Sequence Listing is hereby incorporated herein by reference.

### BACKGROUND

Implantable Cardio Defibrillators (“ICD”) effectively terminate life threatening ventricular tachy-arrhythmias, such as ventricular tachycardia (“VT”) and ventricular fibrillation (“VF”). For many patients, ICDs are indicated for various cardiac related ailments including myocardial infarction, ischemic heart disease, coronary artery disease, and heart failure. The use of these devices, however, remains low due in part to lack of reliable markers to select patients who are in need of these devices. Despite the effectiveness of ICDs in sudden cardiac death or arrest prevention, many patients who might benefit from an ICD do not receive one due to a lack of reliable methods for the identification of Sudden Cardiac Death (“SCD”) or Sudden Cardiac Arrest (“SCA”) in susceptible patients. This is because the standard criterion used for selection of patients has been suboptimal, with only approximately 10% of patients who receive an ICD requiring activation of their device during the life of the patient. A further problem is that most individuals that do receive ICDs never experience a life threatening arrhythmia (LTA). Therefore, it is important to reliably identify who is the most at risk for experiencing an LTA and, thus, who would benefit the most from an ICD. By using the genetic markers, kits and methods identified herein, patient selection for ICD therapy can be improved, and thereby reduce the number of lives lost as a result of SCA.

### SUMMARY OF THE INVENTION

Genetic factors help to identify who is the most at risk of experiencing a life threatening arrhythmia. Novel genetic markers useful in assessing the risk of Sudden Cardiac Death (“SCD”) and Sudden Cardiac Arrest (“SCA”) that can be treated with implantable cardioverting defibrillators (ICDs) are provided herein. Novel diagnostic kits and methods for assessing the risk of Sudden Cardiac Death (“SCD”) and Sudden Cardiac Arrest (“SCA”) using genetic markers thereof are also provided. Methods of distinguishing patients having an increased susceptibility to SCD and SCA using the diagnostic kits and methods, including various DNA microarrays, through use of the genetic markers, alone or in combination with other markers, are also provided. The DNA microarrays can be in situ synthesized oligonucleotides, randomly or non-randomly assembled bead-based arrays, and mechanically assembled arrays of spotted material where the materials can be an oligonucleotide, a cDNA clone, or a Polymerase Chain Reaction (PCR) amplicon.

Specifically, a diagnostic kit for detecting one or more Sudden Cardiac Arrest (SCA)-associated polymorphisms in a genetic sample having at least one probe for assessing the presence of a Single Nucleotide Polymorphism (SNP) in any one of SEQ ID Nos. 1-6 is provided. Also provided is a DNA microarray for detecting one or more Sudden Cardiac Arrest (SCA)-associated polymorphisms in a genetic sample made up of at least one probe for assessing the presence of a Single Nucleotide Polymorphism (SNP) in any one of SEQ ID Nos. 1-6.

The present invention contemplates a diagnostic kit for detecting one or more Single Nucleotide Polymorphisms (SNPs) associated with Sudden Cardiac Arrest (SCA) that is treatable with an Implantable Cardioverter Defibrillator (ICD), comprising at least one probe that is used for assessing the presence of said one or more SNPs in a genetic sample, the SNPs being selected from any one of the following sequences:

| rs number | FASTA sequence allele | SEQ ID No. |
|---|---|---|
| rs11856574 | ggtaggggcagggaaagcatcagaat[A/G]taagatgaaccaggagcatcttata | (SEQ ID No. 1) |
| rs482329 | ggcggtgatggttgctactttttatg[C/G]agggtttttgaaggcgtctctcata | (SEQ ID No. 2) |
| rs3848198* | gttcaccagtaggggactggaaaaa[C/T]aaagttacatccatacaataaagcac | (SEQ ID No. 3) |
| rs6565373 | ggacccccaggatcgtcagggcctcc[C/T]acagctggagtgggaagggagcaga | (SEQ ID No. 4) |
| rs592197 | tgagttaaaaagagaagaggtagtg[C/G]ctggagaacgggaggcttgacgttga | (SEQ ID No. 5) |
| rs556186 | gtaacgaaagtttccactttttgcaa[C/G]ttaccatttatataaagtttaagac | (SEQ ID No. 6) |

*reverse complement

Also contemplated are isolated nucleotides useful to predict SCD, or SCA risk, complementary to any one of SEQ ID Nos. 1-6 for either the major or minor allele where the complement is between from about 12 to 101 nucleotides in length and overlaps a polymorphic position in any of the SEQ ID Nos. 1-6, representing a SNP. In particular, the nucleotide lengths can be described by n for the lower bound, and (n+i) for the upper bound for n={×∈ [symbol] |12<x≦101} and i={y∈ [symbol] |0≦y≦(101−n)}. For example, the isolated nucleotides or complements thereof, can be for n=12, for every i={y∈ [symbol] |0≦y≦(89) from about 12 to 13 nucleotides in length, or from about 12 to 14, 12 to 15, 12 to 17, 12 to 18, . . . , 12 to 99, 12 to 100, 12 to 101, so long as the polymorphic position in any of SEQ ID Nos. 1-6 is overlapped. Similarly, the isolated nucleotides or complements thereof can be from about 15 to 101, 17 to 101, 19 to 101, 21 to 101, 24 to 101, 26 to 101, nucleotides in length, or 15 to 50, 17 to 50, 19 to 50, 21 to 50, 24 to 50, 26 to 50 nucleotides in length, and so forth. Both the major or minor allele can be probed. Preferred primer lengths can be from 25 to 35, 18 to 30, 17 to 24, 15 to 101, 17 to 101, 19 to 101, 21 to 101, 24 to 101, 26 to 101, 15 to 50, 17 to 50, 19 to 50, 21 to 50, 24 to 50, and 26 to 50 nucleotides. A preferred length is 52 nucleotides with the polymorphism at position 26 or 27. An amplified nucleotide is further contemplated containing a SNP embodied in any one of SEQ ID Nos. 1-6, or a complement thereof, overlapping the polymorphic position, wherein the amplified nucleotide is between 12 and 101 base pairs in length described by n for the lower bound, and (n+i) for the upper bound for n={y∈ [symbol] |12<x≦101} and i={y∈ [symbol] |0≦y≦(101−n)}. The lower limit of the number of nucleotides in the isolated nucleotides, and complements thereof, can range from about 12 base pairs from position 26 to 28 in any one of SEQ ID Nos. 1-6 such that the polymorphic position is flanked on either the 5′ and 3′ side by a single base pair, to any number of base pairs flanking the 5′ and 3′ side of the SNP sufficient to adequately identify, or result in hybridization. The lower limit of nucleotides can be from about 12 to 101 base pairs described by n for the lower bound, and (n+i) for the upper bound for n={y∈ [symbol] |12<x≦101} and ={y∈ [symbol] |0≦y≦(101−n)}, the optimal length being determinable by a person of ordinary skill in the art. It is also understood that the optimal length determined by one of ordinary skill in the art may exceed 101 base pairs.

The invention contemplates a system for detecting one or more Single Nucleotide Polymorphisms (SNPs) associated with Sudden Cardiac Arrest (SCA) that is treatable with an Implantable Cardioverter Defibrillator (ICD), comprising a computer system, having a computer processor programmed with a MACH algorithm, and one or more genetic databases that are in communication with the programmed processor, wherein the programmed computer processor is used to impute p-values for one or more known SNPs detected in DNA contained in one or more genetic samples obtained from a patient and/or from the one or more genetic databases, and wherein low p-values indicate an association with SCA that is treatable with an ICD.

The invention also contemplates an isolated nucleic acid molecule useful for predicting Sudden Cardiac Arrest (SCA) that is treatable with an Implantable Cardioverter Defibrillator (ICD), comprising a nucleotide sequence having a Single Nucleotide Polymorphism (SNP).

The invention contemplates a method of distinguishing one or more patients as having an increased or decreased susceptibility to Sudden Cardiac Arrest (SCA) treatable with an Implantable Cardioverter Defibrillator (ICD), comprising the step of imputing p-values for one or more known SNPs detected in DNA contained in one or more genetic samples obtained from a patient and/or from the one or more genetic databases, and wherein p-values below a threshold value of alpha (i.e., alpha=0.05 or 0.01), which can be controlled for multiple comparisons (i.e., Bonferroni correction), indicate increased susceptibility to SCA that is treatable with an ICD.

The invention contemplates a method of detecting a polymorphism associated with Sudden Cardiac Arrest (SCA) that is treatable with an Implantable Cardioverter Defibrillator (ICD), comprising the steps of extracting genetic material from a biological sample and screening said genetic material for at least one Single Nucleotide Polymorphism (SNP) in any of SEQ ID Nos. 1-6.

The invention contemplates a method of distinguishing one or more patients as having an increased or decreased susceptibility to Sudden Cardiac Arrest (SCA) treatable with an Implantable Cardioverter Defibrillator (ICD), comprising the steps of determining the presence or absence of at least one Single Nucleotide Polymorphism (SNP) in any one of SEQ ID Nos. 1-6 in a nucleic acid sample obtained from said one or more patients and assessing susceptibility to SCA based on the determination.

The invention contemplates a polynucleotide useful for predicting Sudden Cardiac Arrest (SCA) that is treatable with an Implantable Cardioverter Defibrillator (ICD), comprising a nucleotide sequence having a Single Nucleotide Polymorphism (SNP) at a polymorphic position in any one of SEQ ID Nos. 1-6.

The invention contemplates an amplified polynucleotide containing a Single Nucleotide Polymorphism (SNP) selected from SEQ ID Nos. 1-6, or a complement thereof. The invention contemplates a DNA microarray for determining the presence or absence one or more polymorphisms associated with Sudden Cardiac Arrest (SCA) that is treatable with an Implantable Cardioverter Defibrillator (ICD) in a genetic sample, comprising at least one probe for detecting a Single Nucleotide Polymorphism (SNP) in any one of SEQ ID Nos. 1-6.

The invention also contemplates a method of determining a risk score for one or more patients as having an increased or decreased susceptibility to Sudden Cardiac Arrest (SCA) where the presence or absence of at least one Single Nucleotide Polymorphism (SNP) in any one of SEQ ID Nos. 1-6 in a nucleic acid sample obtained from said one or more patients is determined, and the number of minor alleles is then determined, and then the increased or decreased susceptibility to SCA is assessed based on the determinations.

Those skilled in the art will recognize that the analysis of the nucleotides present in one or several of the SNP markers in an individual's nucleic acid can be done by any method or technique capable of determining nucleotides present at a polymorphic site. One of skill in the art would also know that the nucleotides present in SNP markers can be determined from either nucleic acid strand or from both strands.

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

### BRIEF DESCRIPTION OF THE DRAWINGS

The foregoing and other features and aspects of the present disclosure will be best understood with reference to the following detailed description of a specific embodiment of the disclosure, when read in conjunction with the accompanying drawings, wherein:

FIG. 1 is a Manhattan Plot of Case subjects with life threatening arrhythmia (LTA) versus Control subjects without LTA. Association values (p-values) are plotted according to position in the genome. The points indicate genotyped (circle) or imputed (triangle) single nucleotide polymorphisms (SNPs). The triangle points represent the SNPs of SEQ ID Nos. 1-4. A line is drawn at p=10⁻⁵, and points above this line are highlighted.

FIGS. 2 and 3 are mosaic plots illustrating the probability of experiencing life threatening arrhythmia (LTA) as a function of allele specific inheritance of SNP rs482329. The horizontal width corresponds to the three genotypes and is proportional to their percentage distribution within the study. The vertical axis divides the case and control groups.

FIGS. 4 and 5 are mosaic plots illustrating the probability of experiencing LTA as a function of allele specific inheritance of SNP rs3848198. The horizontal width corresponds to the three genotypes and is proportional to their percentage distribution within the study. The vertical axis divides the case and control groups.

FIGS. 6 and 7 are mosaic plots illustrating the probability of experiencing LTA as a function of allele specific inheritance of SNP rs11856574. The horizontal width corresponds to the three genotypes and is proportional to their percentage distribution within the study. The vertical axis divides the case and control groups.

FIGS. 8 and 9 are mosaic plots illustrating the probability of experiencing LTA as a function of allele specific inheritance of SNP rs6565373. The horizontal width corresponds to the three genotypes and is proportional to their percentage distribution within the study. The vertical axis divides the case and control groups. The same trend in data is only seen for SNP rs6565373. However, all six markers plotted in FIGS. 2-11 are contemplated as potential candidates for indicating risk of SCA because they are all derived from a larger patient cohort, i.e., the GAME study, which is described herein.

FIG. 10 is a mosaic plot illustrating the probability of experiencing LTA as a function of allele specific inheritance of SNP rs592197. The horizontal width corresponds to the three genotypes and is proportional to their percentage distribution within the study. The vertical axis divides the case and control groups.

FIG. 11 is a mosaic plot illustrating the probability of experiencing LTA as a function of allele specific inheritance of SNP rs556186. The horizontal width corresponds to the three genotypes and is proportional to their percentage distribution within the study. The vertical axis divides the case and control groups.

FIG. 12 describes the data model for the NCBI SNP database and shows the relationship between the SNP reference number (rs number) and ss numbers, accession numbers, and other identifying information.

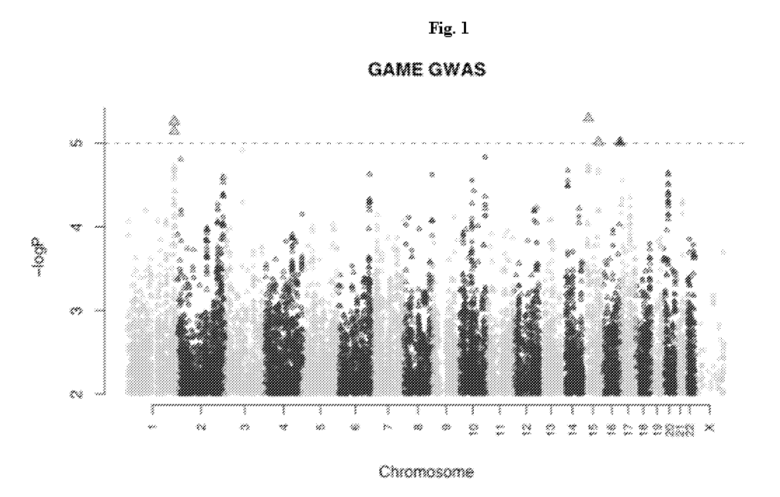

### DETAILED DESCRIPTION OF THE INVENTION

The invention relates to diagnostic kits and methods using a nucleic acid molecule to predict SCD or SCA, the nucleic acid molecule having a SNP in any one of SEQ ID Nos. 1-6 that can be used in the diagnosis, distinguishing, and detecting of susceptibility to SCD or SCA that can be treated with an ICD. In particular, the present invention contemplates a diagnostic kit for detecting one or more Single Nucleotide Polymorphisms (SNPs) associated with Sudden Cardiac Arrest (SCA) that is treatable with an Implantable Cardioverter Defibrillator (ICD), comprising at least one probe that is used for assessing the presence of said one or more SNPs in a genetic sample, the SNPs being selected from any one of the following sequences:

| rs number | FASTA sequence allele | SEQ ID No. |
|---|---|---|
| rs11856574 | ggtaggggcagggaaagcatcagaat[A/G]taagatgaaccaggagcatcttata | (SEQ ID No. 1) |
| rs482329 | ggcggtgatggttgctactttttatg[C/G]agggtttttgaaggcgtctctcata | (SEQ ID No. 2) |
| rs3848198* | gttcaccagtaggggactggaaaaa[C/T]aaagttacatccatacaataaagcac | (SEQ ID No. 3) |
| rs6565373 | ggacccccaggatcgtcagggcctcc[C/T]acagctggagtgggaagggagcaga | (SEQ ID No. 4) |
| rs592197* | tgagttaaaaagagaagaggtagtg[C/G]ctggagaacgggaggcttgacgttga | (SEQ ID No. 5) |
| rs556186 | gtaacgaaagtttccactttttgcaa[C/G]ttaccatttatataaagtttaagac | (SEQ ID No. 6) |

*reverse complement

The invention also relates to an isolated nucleic acid molecule useful in predicting risk of Sudden Cardiac Death (“SCD”) or Sudden Cardiac Arrest (“SCA”) having a Single Nucleotide Polymorphism (SNP) in any one of SEQ ID Nos. 1-6 that can be used in the diagnosis, distinguishing, and detecting of susceptibility to SCD or SCA that can be treated with an implantable cardioverting defibrillator (ICD).

Also contemplated are isolated nucleotides useful to predict SCD, or SCA risk, complementary to any one of SEQ ID Nos. 1-6 for either the major or minor allele where the complement is between from about 12 to 101 nucleotides in length and overlaps a polymorphic position in any of the SEQ ID Nos. 1-6, representing a SNP. In particular, the nucleotide lengths can be described by n for the lower bound, and (n+i) for the upper bound for n={y∈ [symbol] |12<x≦101} and i={y∈ [symbol] |0≦y≦(101−n)}. For example, the isolated nucleotides or complements thereof, can be for n=12, for every i={y∈ [symbol] |0≦y≦(89) from about 12 to 13 nucleotides in length, or from about 12 to 14, 12 to 15, 12 to 17, 12 to 18, . . . , 12 to 99, 12 to 100, 12 to 101, so long as the polymorphic position in any of SEQ ID Nos. 1-6 is overlapped. Similarly, the isolated nucleotides or complements thereof can be from about 15 to 101, 17 to 101, 19 to 101, 21 to 101, 24 to 101, 26 to 101, nucleotides in length, or 15 to 50, 17 to 50, 19 to 50, 21 to 50, 24 to 50, 26 to 50 nucleotides in length, and so forth. Both the major or minor allele can be probed. Preferred primer lengths can be from 25 to 35, 18 to 30, and 17 to 24 nucleotides. A preferred length is 52 nucleotides with the polymorphism at position 26 or 27. An amplified nucleotide is further contemplated containing a SNP embodied in any one of SEQ ID Nos. 1-6, or a complement thereof, overlapping the polymorphic position, wherein the amplified nucleotide is between 12 and 101 base pairs in length described by n for the lower bound, and (n+i) for the upper bound for n={y∈ [symbol] |12<x≦101} and i={y∈ [symbol] |0≦y≦(101−n)}. The lower limit of the number of nucleotides in the isolated nucleotides, and complements thereof, can range from about 12 base pairs from position 26 to 28 in any one of SEQ ID Nos. 1-6 such that the polymorphic position is flanked on either the 5′ and 3′ side by a single base pair, to any number of base pairs flanking the 5′ and 3′ side of the SNP sufficient to adequately identify, or result in hybridization. The lower limit of nucleotides can be from about 12 to 101 base pairs described by n for the lower bound, and (n+i) for the upper bound for n={y∈ [symbol] |12<x≦101} and i={y∈ [symbol] |0≦y≦(101−n)}, the optimal length being determinable by a person of ordinary skill in the art. It is also understood that the optimal length determined by one of ordinary skill in the art may exceed 101 base pairs.

The invention contemplates a system for detecting one or more Single Nucleotide Polymorphisms (SNPs) associated with Sudden Cardiac Arrest (SCA) that is treatable with an Implantable Cardioverter Defibrillator (ICD), comprising a computer system, having a computer processor programmed with a MACH algorithm, and one or more genetic databases that are in communication with the programmed processor, wherein the programmed computer processor is used to impute p-values for one or more known SNPs detected in DNA contained in one or more genetic samples obtained from a patient and/or from the one or more genetic databases, and wherein low p-values indicate an association with SCA that is treatable with an ICD.

The invention also contemplates an isolated nucleic acid molecule useful for predicting Sudden Cardiac Arrest (SCA) that is treatable with an Implantable Cardioverter Defibrillator (ICD), comprising a nucleotide sequence having a Single Nucleotide Polymorphism (SNP).

The invention contemplates a method of distinguishing one or more patients as having an increased or decreased susceptibility to Sudden Cardiac Arrest (SCA) treatable with an Implantable Cardioverter Defibrillator (ICD), comprising the step of imputing p-values for one or more known SNPs detected in DNA contained in one or more genetic samples obtained from a patient and/or from the one or more genetic databases, and wherein p-values below a threshold value of alpha (i.e., alpha=0.05 or 0.01), which can be controlled for multiple comparisons (i.e., Bonferroni correction), indicate increased susceptibility to SCA that is treatable with an ICD.

The invention contemplates a method of detecting a polymorphism associated with Sudden Cardiac Arrest (SCA) that is treatable with an Implantable Cardioverter Defibrillator (ICD), comprising the steps of extracting genetic material from a biological sample and screening said genetic material for at least one Single Nucleotide Polymorphism (SNP) in any of SEQ ID Nos. 1-6.

The invention contemplates a method of distinguishing one or more patients as having an increased or decreased susceptibility to Sudden Cardiac Arrest (SCA) treatable with an Implantable Cardioverter Defibrillator (ICD), comprising the steps of determining the presence or absence of at least one Single Nucleotide Polymorphism (SNP) in any one of SEQ ID Nos. 1-6 in a nucleic acid sample obtained from said one or more patients and assessing susceptibility to SCA based on the determination.

The invention contemplates a polynucleotide useful for predicting Sudden Cardiac Arrest (SCA) that is treatable with an Implantable Cardioverter Defibrillator (ICD), comprising a nucleotide sequence having a Single Nucleotide Polymorphism (SNP) at a polymorphic position in any one of SEQ ID Nos. 1-6.

The invention contemplates an amplified polynucleotide containing a Single Nucleotide Polymorphism (SNP) selected from SEQ ID Nos. 1-6, or a complement thereof. The invention contemplates a DNA microarray for determining the presence or absence one or more polymorphisms associated with Sudden Cardiac Arrest (SCA) that is treatable with an Implantable Cardioverter Defibrillator (ICD) in a genetic sample, comprising at least one probe for detecting a Single Nucleotide Polymorphism (SNP) in any one of SEQ ID Nos. 1-6.

The invention also contemplates a method of determining a risk score for one or more patients as having an increased or decreased susceptibility to Sudden Cardiac Arrest (SCA) where the presence or absence of at least one Single Nucleotide Polymorphism (SNP) in any one of SEQ ID Nos. 1-6 in a nucleic acid sample obtained from said one or more patients is determined, and the number of minor alleles is then determined, and then the increased or decreased susceptibility to SCA is assessed based on the determinations.

### DEFINITIONS

Unless defined otherwise, all technical and scientific terms used herein have the same meaning as commonly understood by one of ordinary skill in the art to which this invention belongs. For purposes of the present invention, the following terms are defined below.

The terms “a,” “an,” and “the” include plural referents unless the context clearly dictates otherwise.

The term “comprising” includes, but is not limited to, whatever follows the word “comprising.” Thus, use of the term indicates that the listed elements are required or mandatory but that other elements are optional and may or may not be present.

The term “consisting of” includes and is limited to whatever follows the phrase the phrase “consisting of.” Thus, the phrase indicates that the limited elements are required or mandatory and that no other elements may be present.

The phrase “consisting essentially of” includes any elements listed after the phrase and is limited to other elements that do not interfere with or contribute to the activity or action specified in the disclosure for the listed elements. Thus, the phrase indicates that the listed elements are required or mandatory but that other elements are optional and may or may not be present, depending upon whether or not they affect the activity or action of the listed elements.

The term “plurality” as described herein means more than one, and also defines a multiple of items.

The term “isolated” refers to nucleic acid, or a fragment thereof, that has been removed from its natural cellular environment.

The term “nucleic acid” refers to a deoxyribonucleotide or ribonucleotide polymer in either single- or double-stranded form, and, unless otherwise limited, encompasses known analogues of natural nucleotides that hybridize to nucleic acids in a manner similar to naturally occurring nucleotides. The term “nucleic acid” encompasses the terms “oligonucleotide” and “polynucleotide.”

The term “amplified polynucleotide” or “amplified nucleotide” as used herein refers to polynucleotides or nucleotides that are copies of a portion of a particular polynucleotide sequence and/or its complementary sequence, which correspond to a template polynucleotide sequence and its complementary sequence. An “amplified polynucleotide” or “amplified nucleotide” according to the present invention, may be DNA or RNA, and it may be double-stranded or single-stranded.

“Synthesis” and “amplification” as used herein are used interchangeably to refer to a reaction for generating a copy of a particular polynucleotide sequence or increasing in copy number or amount of a particular polynucleotide sequence. It may be accomplished, without limitation, by the in vitro methods of polymerase chain reaction (PCR), ligase chain reaction (LCR), polynucleotide-specific based amplification (NSBA), or any other method known in the art. For example, polynucleotide amplification may be a process using a polymerase and a pair of oligonucleotide primers for producing any particular polynucleotide sequence, i.e., the target polynucleotide sequence or target polynucleotide, in an amount which is greater than that initially present.

As used herein, the term “primer pair” means two oligonucleotides designed to flank a region of a polynucleotide to be amplified.

The term “MACH” or “MACH 1.0” refers to a haplotyper program using a Hidden Markov Model (HMM) that can resolve long haplotypes or infer missing genotypes in samples of unrelated individuals as known within the art.

The term “Hidden Markov Model (HMM)” describes a statistical method for determining a state, which has not been observed or “hidden.” The HMM is generally based on a Markov chain, which describes a series of observations in which the probability of an observation depends on a number of previous observations. For a HMM, the Markov process itself cannot be observed, but only the steps in the sequence.

As used herein, an implantable cardioverter-defibrillator (ICD) is a small battery-powered electrical impulse generator implanted in patients who are at risk of sudden cardiac death due to ventricular fibrillation and/or ventricular tachycardia. The device is programmed to detect cardiac arrhythmia and correct it by delivering a jolt of electricity. In known variants, the ability to revert ventricular fibrillation has been extended to include both atrial and ventricular arrhythmias as well as the ability to perform biventricular pacing in patients with congestive heart failure or bradycardia.

“Single nucleotide polymorphisms” (SNPs) refers to a variation in the sequence of a gene in the genome of a population that arises as the result of a single base change, such as an insertion, deletion or, a change in a single base. A locus is the site at which divergence occurs.

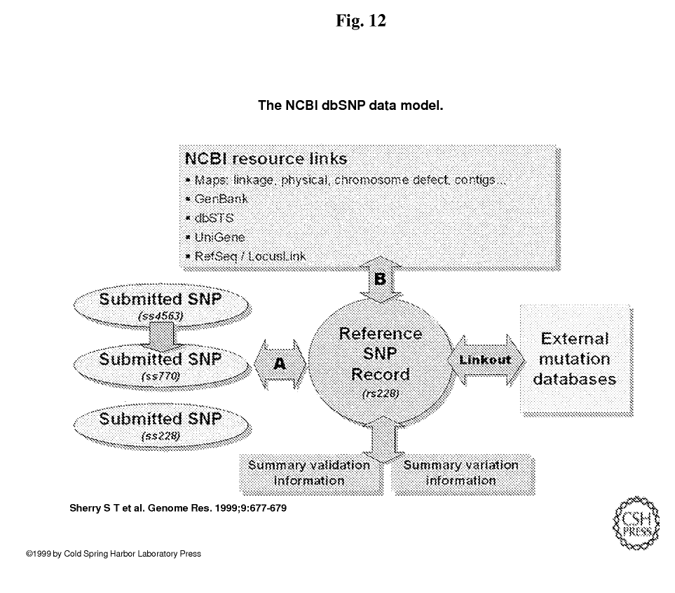

An “rs number” refers to a SNP database record archived and curated on dbSNP, which is a database for Single Polymorphism Polynucleotides and Other Classes of Minor Genetic Variations. The dbSNP database maintains two types of records: ss records of each original submission and rs records. The ss records may represent variations in submissions for the same genome location. The rs numbers represent a unique record for a SNP and are constructed and periodically reconstructed based on subsequent submissions and Builds. In each new build cycle, the set of new data entering each build typically includes all submissions received since the close of data in the previous build. Some refSNP (rs) numbers might have been merged if they are found to map the same location at a later build, however, it is understood that a particular rs number with a Build number provides the requisite detail so that one of ordinary skill in the art will be able to make and use the invention as contemplated herein. Hence, one of ordinary skill will generally be able to determine a particular SNP by reviewing the entries for an rs number and related ss numbers. Data submitted to the NCBI database are clustered and provide a non-redundant set of variations for each organism in the database. The clusters are maintained as rs numbers in the database in parallel to the underlying submitted data. Reference Sequences, or RefSeqs, are a curated, non-redundant set of records for mRNAs, proteins, contigs, and gene regions constructed from a GenBank exemplar for that protein or sequence. The accession numbers under “Submitter-Referenced Accessions” is annotation that is included with a submitted SNP (ss) when it is submitted to dbSNP as shown in FIG. 12 (Sherry et al., dbSNP—Database for Single Polymorphism Polynucleotides and Other Classes of Minor Genetic Variation, GENOME RES. 1999; 9: 677-679). However, other alternate forms of the rs number as provided in RefSeq, ss numbers, etc. are contemplated by the invention such that one of ordinary skill in the art would understand that the scope and nature of the invention is not departed by using follow-on builds of dbSNP.

“Probes” or “primers” refer to single-stranded nucleic acid sequences that are complementary to a desired target nucleic acid. The 5′ and 3′ regions flanking the target complement sequence reversibly interact by means of either complementary nucleic acid sequences or by attached members of another affinity pair. Hybridization can occur in a base-specific manner where the primer or probe sequence is not required to be perfectly complementary to all of the sequences of a template. Hence, non-complementary bases or modified bases can be interspersed into the primer or probe, provided that base substitutions do not inhibit hybridization. The nucleic acid template may also include “nonspecific priming sequences” or “nonspecific sequences” to which the primers or probes have varying degrees of complementarity. As used in the phrase “priming polynucleotide synthesis,” a probe is described that is of sufficient length to initiate synthesis during PCR. In certain embodiments, a probe or primer comprises 101 or fewer nucleotides, wherein the length of the complement is described by a length n for the lower bound, and (n+i) for the upper bound for n={y∈ [symbol] |0<x≦101} and i={y∈ [symbol] |0≦y≦(101−n)}, or from about any number of base pairs flanking the 5′ and 3′ side of a region of interest to sufficiently identify, or result in hybridization. Further, the ranges can be chosen from group A and B, where for A, the probe or primer is greater than 5, greater than 10, greater than 15, greater than 20, greater than 25, greater than 30, greater than 40, greater than 50, greater than 60, greater than 70, greater than 80, greater than 90 and greater than 100 base pairs in length. For B, the probe or primer is less than 102, less than 95, less than 90, less than 85, less than 80, less than 75, less than 70, less than 65, less than 60, less than 55, less than 50, less than 45, less than 40, less than 35, less than 30, less than 25, less than 20, less than 15, or less than 10 base pairs in length. In other embodiments, the probe or primer is at least 70% identical to the contiguous nucleic acid sequence or to the complement of the contiguous nucleotide sequence, for example, at least 80% identical, at least 90% identical, at least 95% identical, and is capable of selectively hybridizing to the contiguous nucleic acid sequence or to the complement of the contiguous nucleotide sequence. Preferred primer lengths include 25 to 35, 18 to 30, and 17 to 24 nucleotides. Often, the probe or primer further comprises a “label,” e.g., radioisotope, fluorescent compound, enzyme, or enzyme co-factor. One primer is complementary to nucleotides present on the sense strand at one end of a polynucleotide to be amplified and another primer is complementary to nucleotides present on the antisense strand at the other end of the polynucleotide to be amplified. The polynucleotide to be amplified can be referred to as the template polynucleotide. The nucleotides of a polynucleotide to which a primer is complementary is referred to as a target sequence. A primer can have at least about 15 nucleotides, preferably, at least about 20 nucleotides, most preferably, at least about 25 nucleotides. Typically, a primer has at least about 95% sequence identity, preferably at least about 97% sequence identity, most preferably, about 100% sequence identity with the target sequence to which the primer hybridizes. The conditions for amplifying a polynucleotide by PCR vary depending on the nucleotide sequence of primers used, and methods for determining such conditions are routine in the art.

To obtain high quality primers, primer length, melting temperature (Tₘ), GC content, specificity, and intra- or inter-primer homology are taken into account in the present invention. You et al., BatchPrimer3: A high throughput web application for PCR and sequencing primer design, BMC BIOINFORMATICS, 2008; 9:253; Yang X., Scheffler B E, Weston L A, Recent developments in primer design for DNA polymorphism and mRNA profiling in higher plants, PLANT METHODS, 2006; 2(1):4. Primer specificity is related to primer length and the final 8 to 10 bases of the 3′ end sequence where a primer length of 18 to 30 bases is one possible embodiment. Abd-Elsalam K A, Bioinformatics tools and guideline for PCR primer design, AFRICA J. OF BIOTECHNOLOGY 2003; 2(5):91-95. Tₘ is closely correlated to primer length, GC content and primer base composition. One possible ideal primer Tₘ is in the range of 50 to 65° C. with GC content in the range of 40 to 60% for standard primer pairs. Dieffenbatch C W, Lowe T M J, Dveksler G S, General concepts for PCR primer design, PCR PRIMER, A LABORATORY MANUAL, Eds: Dieffenbatch C W, Dveksler G S, New York, Cold Spring Harbor Laboratory Press, 1995; 133-155. However, the optimal primer length varies depending on different types of primers. For example, SNP genotyping primers may require a longer primer length of 25 to 35 bases to enhance their specificity, and thus the corresponding Tₘ might be higher than 65° C. Also, a suitable Tₘ can be obtained by setting a broader GC content range (20 to 80%).

The probes or primers can also be variously referred to as “antisense nucleic acid molecules,” “polynucleotides,” or “oligonucleotides” and can be constructed using chemical synthesis and enzymatic ligation reactions known in the art. For example, an antisense nucleic acid molecule (e.g., an antisense oligonucleotide) can be chemically synthesized using naturally occurring nucleotides or variously modified nucleotides designed to increase the biological stability of the molecules or to increase the physical stability of the duplex formed between the antisense and sense nucleic acids. The primers or probes can further be used in “Polymerase Chain Reaction” (PCR), a well known amplification and analytical technique that generally uses two “primers” of short, single-stranded DNA synthesized to correspond to the beginning of a DNA stretch to be copied, and a polymerase enzyme that moves along the segment of DNA to be copied that assembles the DNA copy.

The term “genetic material” and/or “genetic sample” refers to a nucleic acid sequence that is sought to be obtained from any number of sources, including, without limitation, whole blood, a tissue biopsy, lymph, bone marrow, hair, skin, saliva, buccal swabs, purified samples generally, cultured cells, and lysed cells, and can comprise any number of different compositional components (e.g., DNA, RNA, tRNA, siRNA, mRNA, or various non-coding RNAs). The nucleic acid can be isolated from samples using any of a variety of procedures known in the art. In general, the target nucleic acid will be single stranded, though in some embodiments the nucleic acid can be double stranded, and a single strand can result from denaturation. It will be appreciated that either strand of a double-stranded molecule can serve as a target nucleic acid to be obtained. The nucleic acid sequence can be methylated, non-methylated, or both and can contain any number of modifications. Further, the nucleic acid sequence can refer to amplification products as well as to the native sequences.

The term “screening” within the phrase “screening for a genetic sample” means any testing procedure known to those of ordinary skill in the art to determine the genetic make-up of a genetic sample.

As used herein, “hybridization” is defined as the ability of two nucleotide sequences to bind with each other based on a degree of complementarity of the two nucleotide sequences, which in turn is based on the fraction of matched complementary nucleotide pairs. The more nucleotides in a given sequence that are complementary to another sequence, the more stringent the conditions can be for hybridization and the more specific will be the binding of the two sequences. Increased stringency is achieved by elevating the temperature, increasing the ratio of co-solvents, lowering the salt concentration, and the like. Stringent conditions are conditions under which a probe can hybridize to its target subsequence, but to no other sequences. Stringent conditions are sequence-dependent and are different in different circumstances. Longer sequences hybridize specifically at higher temperatures. Generally, stringent conditions are selected to be about 5° C. lower than the thermal melting point (Tm) for the specific sequence at a defined ionic strength and pH. The Tm is the temperature (under defined ionic strength, pH, and nucleic acid concentration) at which 50% of the probes complementary to the target sequence hybridize to the target sequence at equilibrium. Typically, stringent conditions include a salt concentration of at least about 0.01 to 1.0 M Na ion concentration (or other salts) at pH 7.0 to 8.3 and the temperature is at least about 30° C. for short probes (e.g., 10 to 50 nucleotides). Stringent conditions can also be achieved with the addition of destabilizing agents such as formamide or tetraalkyl ammonium salts. For example, conditions of SxSSPE (750 mM NaCl, 50 mM Na Phosphate, 5 mM EDTA, pH 7.4) and a temperature of 25-30° C. are suitable for allele-specific probe hybridizations. Sambrook et al., MOLECULAR CLONING, 1989.

Allele Specific Oligomer (“ASO”) refers to a primary oligonucleotide having a target specific portion and a target-identifying portion, which can query the identity of an allele at a SNP locus. The target specific portion of the ASO of a primary group can hybridize adjacent to the target specific portion and can be made by methods well known to those of ordinary skill.

The ordinary meaning of the term “allele” is one of two or more alternate forms of a gene occupying the same locus in a particular chromosome or linkage structure and differing from other alleles of the locus at one or more mutational sites. Rieger et al., GLOSSARY OF GENETICS, 5TH ED., Springer-Verlag, Berlin 1991; 16.

Bi-allelic and multi-allelic refers to two, or more than two alternate forms of a SNP, respectively, occupying the same locus in a particular chromosome or linkage structure and differing from other alleles of the locus at a polymorphic site.

The phrase “assessing the presence” of one or more SNPs in a genetic sample encompasses any known process that can be implemented to determine if a polymorphism is present in a genetic sample. For example, amplified DNA obtained from a genetic sample can be labeled before it is hybridized to a probe on a solid support. The amplified DNA is hybridized to probes which are immobilized to known locations on a solid support, e.g., in an array, microarray, high density array, beads or microtiter dish. The presence of labeled amplified DNA products hybridized to the solid support indicates that the nucleic acid sample contains at the polymorphic locus a nucleotide which is indicative of the polymorphism. The quantities of the label at distinct locations on the solid support can be compared, and the genotype can be determined for the sample from which the DNA was obtained. Two or more pairs of primers can be used for determining the genotype of a sample. Each pair of primers specifically amplifies a different allele possible at a given SNP.

The term “detecting” is used to describe any known process for detection. For example, nucleic acids can be detected by hybridization, observation of one or more labels attached to target nucleic acids, or any other convenient means known to those of ordinary skill. A label can be incorporated by labeling the amplified DNA product using a terminal transferase and a fluorescently labeled nucleotide. Useful detectable labels include labels that can be detected by spectroscopic, photochemical, biochemical, immunochemical, electrical, optical, or chemical means. Radioactive labels can be detected using photographic film or scintillation counters. Fluorescent labels can be detected using a photodetector.

The term “detecting” as used in the phrase “detecting one or more Single Nucleotide Polymorphisms (SNPs)” refers to any suitable method for determining the identity of a nucleotide at a position including, but not limited to, sequencing, allele specific hybridization, primer specific extension, oligonucleotide ligation assay, restriction enzyme site analysis and single-stranded conformation polymorphism analysis.

In double-stranded DNA, only one strand codes for the RNA that is translated into protein. This DNA strand is referred to as the “antisense” strand. The strand that does not code for RNA is called the “sense” strand. Another way of defining antisense DNA is that it is the strand of DNA that carries the information necessary to make proteins by binding to a corresponding messenger RNA (mRNA). Although these strands are exact minor images of one another, only the antisense strand contains the information for making proteins. “Antisense compounds” are oligomeric compounds that are at least partially complementary to a target nucleic acid molecule to which they hybridize. In certain embodiments, an antisense compound modulates (increases or decreases) expression of a target nucleic acid. Antisense compounds include, but are not limited to, compounds that are oligonucleotides, oligonucleosides, oligonucleotide analogs, oligonucleotide mimetics, and chimeric combinations of these. Consequently, while all antisense compounds are oligomeric compounds, not all oligomeric compounds are antisense compounds.

Mutations are changes in a genomic sequence. As used herein, “naturally occurring mutants” refers to any preexisting, not artificially induced change in a genomic sequence. Mutations, mutant sequences, or, simply, “mutants” include additions, deletions and substitutions or one or more alleles.

The optimal probe length, position, and number of probes for detection of a single nucleotide polymorphism or for hybridization may vary depending on various hybridization conditions. Thus, the phrase “sufficient to identify the SNP or result in a hybridization” is understood to encompass design and use of probes such that there is sufficient specificity and sensitivity to detect and identify a SNP sequence or result in a hybridization. Hybridization is described in further detail above.

The phrases “increased susceptibility,” “decreased susceptibility,” or the term “risk,” generally, relates to the possibility or probability of a particular event occurring either presently or at some point in the future. Determining an increase or decrease in susceptibility to a medical disease, disorder or condition involves “risk stratification” or “assessing susceptibility,” which refers to an analysis of known clinical risk factors that allows physicians and others of skill in the relevant art to classify patients from a low to high range of risk of developing a particular disease, disorder, or condition.

The phrase “selectively hybridizing” refers to the ability of a probe used in the invention to hybridize, with a target nucleotide sequence with specificity.

The term “treatable” means that a patient is potentially or would be expected to be responsive to a particular form of treatment.

A “diagnostic kit” means any medical device which is a reagent, reagent product, calibrator, control material, kit, instrument, apparatus, equipment, or system, whether used alone or in combination, that is used for the examination of specimens, including blood and tissue donations, genetic samples, derived from a patient, solely or principally for the purpose of providing information about a physiological or pathological state, or concerning a congenital abnormality, or to determine the safety and compatibility with potential recipients, or to monitor therapeutic measures. The specific “diagnostic kits” of the invention are defined more fully herein.

In statistical significance testing, the “p-value” is the probability of obtaining a test statistic at least as extreme as the one that was actually observed, assuming that the null hypothesis is true. The lower the p-value, the less likely the result is if the null hypothesis is true, and consequently the more “significant” the result is, in the sense of statistical significance.

A “low p-value”, as described herein is a value below an alpha value (i.e., alpha=0.05 or 0.01) that can be controlled for multiple comparisons (i.e., Bonferroni correction).

A “polymorphic position” or “polymorphic site” is defined as a position in a nucleotide wherein a single nucleotide differs between other nucleotides within a population or paired chromosomes as shown herein.

A “major allele” is defined as a more common nucleotide or an allele having a greater frequency in comparison to other alleles. A “minor allele” is a less common nucleotide or an allele having a lesser frequency.

As used herein, to impute a p-value to one or more SNPs outside of a test sample means to mathematically attribute a p-value to one or more known and documented SNPs, using the methods described herein, that are not present on the test microchips used in a specific experiment or study. Using the p-values obtained from the tested microchips, p-values may be mathematically imputed to other known SNPs using an “algorithm” or “algorithms” such as those described herein.

By the phrase “indicate association” or “associated with,” it is meant that statistical analysis suggests, by, for example, a p-value, that a SNP may be linked to a particular medical disease, condition, or disorder.

The terms “processor” and “computer processor” as used herein are broad terms and are to be given their ordinary and customary meaning to a person of ordinary skill in the art. The terms refer without limitation to a computer system, state machine, processor, or the like designed to perform arithmetic or logic operations using logic circuitry that responds to and processes the basic instructions that drive a computer. In some embodiments, the terms can include ROM (“read-only memory”) and/or RAM (“random-access memory”) associated therewith.

“Genetic database” refers generally to a database containing genetic sequence information.

By the phrase, “in communication,” it is meant that the elements of the system of the invention are so connected, either directly or remotely, that data can be communicated among and between said elements.

The term “isolated” as used herein with reference to a nucleic acid molecule refers to a nucleic acid that is not immediately contiguous with both of the sequences with which it is immediately contiguous in the naturally occurring genome of the organism from which it is derived. The term “isolated” also includes any non-naturally occurring nucleic acid because such engineered or artificial nucleic acid molecules do not have immediately contiguous sequences in a naturally occurring genome.

The phrase, “affixed to a substrate,” refers to the process of attaching probes of DNA to a substrate so that a target sample is bound or hybridized with the probes. The surface of the substrate is chemically prepared or derivatized to enable or facilitate the attachment or affixment of the molecular species to the surface of the array substrate. This process is described in detail below.

The term “extracting” information or genetic material broadly encompasses any process by which genetic information such as nucleotide sequence, polymorphism or other characteristic of the genetic material can be observed and processed into information either electronic, analog, or other form by any means known to those of ordinary skill in the art.

As used herein, a “risk score” is defined as a predisposition to a condition. Generally, a risk can be expressed as a percentage for an indication of the likeliness of the chance event, such as a medically defined phenotype, such as a condition or a non-medical phenotype, such as a trait, to occur. “Risk scores” can be provided with a confidence interval, a statistical value such as a p-value, Z-score, correlation (e.g., R or R2), chi-square, f-value, t-value or both a confidence interval and a statistical value, indicating the strength of correlation between the score and the condition or trait thereof. Scores can be generated for an individual's risks or predispositions for medical conditions based on an individual's genetic profile. Scores can be determined for a specific phenotype (e.g., disease, disorder, condition or trait), for an organ system, for a specific organ, for a combination of phenotypes for a combination of phenotype(s) and organ(s) or organ system(s), for overall health, or for overall genetic predisposition to or risk of specific phenotypes. The phenotype may be a medical condition, for example, scores can be generated for an individual's risks or predispositions for medical conditions based on an individual's genetic profile. Alternatively, scores can be for non-medical conditions, or for both medical and non-medical conditions. Scores may be generated by methods known in the arts, such as described in PCT Publication WO2008/067551 and U.S. Publication No. 20080131887 (each of which is incorporated herein by reference in its entirety) methods such as described herein, or variations and combinations thereof. In some cases, the risks may be determined using a special purpose computer using instructions provided on computer readable medium. Inclusion of the specific algorithms described herein to analyze the genetic information and calculate scores representing risks, predisposition to a phenotype and/or overall health profiles, for example, transform a general purpose computer into a special purpose computer for analyzing the genetic variants identified. Such algorithms can be provided in any combination to execute those functions desired by a client. Thus, the computer system may include some or all of the computer executable logic encoded on computer readable medium to instruct the computer system to complete the analysis, evaluations, scoring of the identified genetic variants, recommendations and reports for the client as desired. In some embodiments, the calculated or determined risk or predisposition of one or more specific phenotypes from an individual's genetic profile provides a measure of the relative risk or predisposition of that individual for one or more phenotypes, as further described herein. The relative risk may be determined as compared to the general population or as compared to a control (e.g., a different individual) lacking one or more of the genetic variants identified in the individual's genetic profile.

In some cases, an individual with an increased relative risk or predisposition for a specific phenotype may be an individual with an odds ratio of greater than 1 for the specific phenotype, for example an individual with an odds ratio of about 1.01, 1.05, 1.1, 1.2, 1.5, 2, 2.5, 3, 4, 5, 6, 7, 8, 9, 10, 15, 20, 25, 50, or 100 or more for developing a phenotype relative to the general population or a control individual. In some cases, an individual with an increased risk or predisposition may be an individual with a greater than 0% increased probability of a phenotype, for example an individual may have a 0.001% greater probability of a phenotype based on their genetic profile, a 0.01% greater probability, a 1% greater probability, a 5% greater probability, a 10% greater probability, a 20% greater probability, a 30% greater probability, a 50% greater probability, a 75% greater probability, a 100% greater probability, a 200%, 300%, 400%, 500% or more greater probability of a phenotype relative to the general population or a control individual. In some cases, an individual with an increased risk or predisposition may be an individual with a greater than 1 fold increased probability of a phenotype relative to a control individual or the general population such as for example about a 1.01 fold, 1.1 fold, 1.2 fold, 1.3 fold, 1.4 fold, 1.5 fold, 2 fold, 3 fold, 5 fold, 10 fold, 100 fold or more increased probability of a phenotype relative to a control individual or the general population. Increased risk or increased predisposition may also be determined using other epidemiological methods such as for example calculation of a hazard ratio or a relative risk.

In some cases, an individual with a decreased risk or decreased predisposition for a specific phenotype is an individual with an odds ratio of less than 1, for example 0.99, 0.9, 0.8, 0.7, 0.5, 0.4, 0.2, 0.1, 0.01 or lower odds ratio relative to a control individual or relative to the general population. An individual with a decreased risk or predisposition for a specific phenotype may be an individual with a lower percentage probability than a control individual or the general population for a phenotype. For example, the individual may have a 0.1% lower risk, 1% lower risk, 5% lower risk, 10% lower risk, 15% lower risk, 25% lower risk, 30% lower risk, 40% lower risk, 50% lower risk, 75% lower risk, or 100% lower risk than a control individual or the general population for a phenotype. An individual's decreased risk or predisposition may also be determined as a hazard ratio or a relative risk.

Four letter symbols are used to represent nucleotides: cytosine (C), guanine (G), adenine (A), and thymine (T). The structure of various alleles is described by any one of the nucleotide symbols shown in Table 1.

TABLE 1
Allele Key used in Sequence Listings

| Nucleotide symbol | Full Name |
|---|---|
| R | Guanine/Adenine (purine) |
| Y | Cytosine/Thymine (pyrimidine) |
| K | Guanine/Thymine |
| M | Adenine/Cytosine |
| S | Guanine/Cytosine |
| W | Adenine/Thymine |
| B | Guanine/Thymine/Cytosine |
| D | Guanine/Adenine/Thymine |
| H | Adenine/Cytosine/Thymine |
| V | Guanine/Cytosine/Adenine |
| N | Adenine/Guanine/Cytosine/Thymine |

### DNA Microarrays and Kits

The present invention provides methods for detecting a polynucleotide including at least a portion of the nucleotides represented by SEQ ID Nos. 1-6. The portions are defined as nucleotide lengths sufficient to result in allele specific hybridization and to characterize the polymorphic site, either at position 26 or 27 in SEQ ID Nos. 1-6 as defined herein. Preferably, the polynucleotide includes the entire genomic sequence represented by SEQ ID Nos. 1-6. In one aspect, the method includes amplifying nucleotides complementary to SEQ ID Nos. 1-6 of an individual to form amplified polynucleotides, and detecting the amplified polynucleotides. Preferably, nucleotides are amplified by PCR. In PCR, a molar excess of a primer pair is added to a biological sample that includes polynucleotides, preferably genomic DNA. The primers are extended to form complementary primer extension products which act as a template for synthesizing the desired amplified polynucleotides.

The methods that include amplifying nucleotides complementary to SEQ ID Nos. 1-6 of an individual may be used to identify an individual not at risk for developing SCA. In this aspect, the primer pair includes primers that flank the polymorphism contained in the SEQ ID Nos. 1-6. After amplification, the sizes of the amplified polynucleotides may be determined, for instance by gel electrophoresis, and compared. The amplified polynucleotides can be visualized by staining (e.g., with ethidium bromide) or labeling with a suitable label known to those skilled in the art, including radioactive and nonradioactive labels. Typical radioactive labels include ³³P. Nonradioactive labels include, for example, ligands such as biotin or digoxigenin as well as enzymes such as phosphatase or peroxidases, or the various chemiluminescers such as luciferin, or fluorescent compounds like fluorescein and its derivatives.

Numerous forms of diagnostic kits employing arrays of nucleotides are known in the art. They can be fabricated by any number of known methods including photolithography, pipette, drop-touch, piezoelectric, spotting and electric procedures. The DNA microarrays generally have probes that are supported by a substrate so that a target sample is bound or hybridized with the probes. In use, the microarray surface is contacted with one or more target samples under conditions that promote specific, high-affinity binding of the target to one or more of the probes. A sample solution containing the target sample typically contains radioactively, chemoluminescently or fluorescently labeled molecules that are detectable. The hybridized targets and probes can also be detected by voltage, current, or electronic means known in the art.

Optionally, a plurality of microarrays may be formed on a larger array substrate. The substrate can be diced into a plurality of individual microarray dies in order to optimize use of the substrate. Possible substrate materials include siliceous compositions where a siliceous substrate is generally defined as any material largely comprised of silicon dioxide. Natural or synthetic assemblies can also be employed. The substrate can be hydrophobic or hydrophilic or capable of being rendered hydrophobic or hydrophilic and includes inorganic powders such as silica, magnesium sulfate, and alumina; natural polymeric materials, particularly cellulosic materials and materials derived from cellulose, such as fiber-containing papers, e.g., filter paper, chromatographic paper, etc.; synthetic or modified naturally occurring polymers, such as nitrocellulose, cellulose acetate, poly(vinyl chloride), polyacrylamide, cross linked dextran, agarose, polyacrylate, polyethylene, polypropylene, poly(4-methylbutene), polystyrene, polymethacrylate, poly(ethylene terephthalate), nylon, poly(vinyl butyrate), etc.; either used by themselves or in conjunction with other materials; glass available as Bioglass, ceramics, metals, and the like. The surface of the substrate is then chemically prepared or derivatized to enable or facilitate the attachment or affixment of the molecular species to the surface of the array substrate. Surface derivatizations can differ for immobilization of prepared biological material, such as cDNA, and in situ synthesis of the biological material on the microarray substrate. Surface treatment or derivatization techniques are well known in the art. The surface of the substrate can have any number of shapes, such as strip, plate, disk, rod, particle, including bead, and the like. In modifying siliceous or metal oxide surfaces, one technique that has been used is derivatization with bifunctional silanes, i.e., silanes having a first functional group enabling covalent binding to the surface and a second functional group that can impart the desired chemical and/or physical modifications to the surface to covalently or non-covalently attach ligands and/or the polymers or monomers for the biological probe array. Adsorbed polymer surfaces are used on siliceous substrates for attaching nucleic acids, for example cDNA, to the substrate surface. Since a microarray die may be quite small and difficult to handle for processing, an individual microarray die can also be packaged for further handling and processing. For example, the microarray may be processed by subjecting the microarray to a hybridization assay while retained in a package.

Various techniques can be employed for affixing an oligonucleotide for use in a microarray. In situ synthesis of oligonucleotide or polynucleotide probes on a substrate is performed in accordance with well-known chemical processes, such as sequential addition of nucleotide phosphoramidites to surface-linked hydroxyl groups. Indirect synthesis may also be performed in accordance with biosynthetic techniques such as Polymerase Chain Reaction (“PCR”). Other methods of oligonucleotide synthesis include phosphotriester and phosphodiester methods and synthesis on a support, as well as phosphoramidate techniques. Chemical synthesis via a photolithographic method of spatially addressable arrays of oligonucleotides bound to a substrate made of glass can also be employed. The affixed probes or oligonucleotides, themselves, can be obtained by biological synthesis or by chemical synthesis. Chemical synthesis provides a convenient way of incorporating low molecular weight compounds and/or modified bases during specific synthesis steps. Furthermore, chemical synthesis is very flexible in the choice of length and region of target polynucleotides binding sequence. The oligonucleotide can be synthesized by standard methods such as those used in commercial automated nucleic acid synthesizers.

Immobilization of probes or oligonucleotides on a substrate or surface may be accomplished by well-known techniques. One type of technology makes use of a bead-array of randomly or non-randomly arranged beads. A specific oligonucleotide or probe sequence is assigned to each bead type, which is replicated any number of times on an array. A series of decoding hybridizations is then used to identify each bead on the array. The concept of these assays is very similar to that of DNA chip based assays. However, oligonucleotides are attached to small microspheres rather than to a fixed surface of DNA chips. Bead-based systems can be combined with most of the allele-discrimination chemistry used in DNA chip based array assays, such as single-base extension and oligonucleotide ligation assays. The bead-based format has flexibility for multiplexing and SNP combination. In bead-based assays, the identity of each bead is determined where that information is combined with the genotype signal from the bead to assign a “genotype call” to each SNP and individual.

One bead-based genotyping technology uses fluorescently coded microspheres developed by Luminex. Fulton R., et al, Advanced multiplexed analysis with the FlowMetrix system, CLIN. CHEM., 1997; 43: 1749-56. These beads are coated with two different dyes (red and orange), and can be identified and separated using flow cytometry, based on the amount of these two dyes on the surface. By having a hundred types of microspheres with a different red:orange signal ratio, a hundred-plex detection reaction can be performed in a single tube. After the reaction, these microspheres are distinguished using a flow fluorimeter where a genotyping signal (green) from each group of microspheres is measured separately. This bead-based platform is useful in allele-specific hybridization, single-base extension, allele-specific primer extension, and oligonucleotide ligation assay. In a different bead-based platform commercialized by Illumina, microspheres are captured in solid wells created from optical fibers. Michael K. et al., Randomly ordered addressable high-density optical sensor arrays, ANAL. CHEM., 1998; 70: 1242-48; Steemers F. et al., Screening unlabeled DNA targets with randomly ordered fiber-optic gene arrays, NAT. BIOTECHNOL., 2000; 18: 91-94. The diameter of each well is similar to that of the spheres, allowing only a single sphere to fit in one well. Once the microspheres are set in these wells, all of the spheres can be treated like a high-density microarray. The high degree of replication in DNA microarray technology makes robust measurements for each bead type possible. Bead-array technology is particularly useful in SNP genotyping. Software used to process raw data from a DNA microarray or chip is well known in the art and employs various known methods for image processing, background correction and normalization. Many available public and proprietary software packages are available for such processing whereby a quality assessment of the raw data can be carried out, and the data then summarized and stored in a format which can be used by other software to perform additional analyses.

Hybridization probes can be labeled with a radioactive substance for easy detection. Grunstein et al. (PROC. NATL. ACAD. SCI. USA, 1975; 72:3961) and Southern (J. MOL. BIOL., 1975; 98:503) describe hybridization techniques using radio-labeled nucleic acid probes. Advantageously, nucleic acid hybridization probes can have high sensitivity and specificity. Radioactive labels can be detected with a phosphor imager or autoradiography film. Radioactive labels are most often used with nylon membrane macro-arrays. Suitable radioactive labels can be, for example, but not limited to isotopes like ¹²⁵I or ³²P. The detection of radioactive labels is, for example, performed by the placement of medical X-ray film directly against the substrate which develops as it is exposed to the label, which creates dark regions which correspond to the emplacement of the probes of interest.

Known methods of electrically detecting hybridization can be used such as electrochemical impedance spectroscopy. This technique can be used to investigate the changes in interfacial electrical properties that arise when DNA-modified Si(1 1 1) surfaces are exposed to solution-phase DNA oligonucleotides with complementary and non-complementary sequences. The n- and p-type silicon(1 1 1) samples can be covalently linked to DNA molecules via direct Si—C linkages without any intervening oxide layer. Exposure to solutions containing DNA oligonucleotides with the complementary sequence can produce significant changes in both the real and imaginary components of electrical impedance, while exposure to DNA with non-complementary sequences generate negligible responses. These changes in electrical properties can be corroborated with fluorescence measurements and reproduced in multiple hybridization-denaturation cycles. Additionally, the ability to detect DNA hybridization is strongly frequency-dependent wherein modeling of the response and comparison of results on different silicon bulk doping shows that the sensitivity to DNA hybridization arises from DNA-induced changes in the resistance of the silicon substrate and the resistance of the molecular layers. Wei et al., Direct electrical detection of hybridization at DNA-modified silicon surfaces, BIOSENSORS AND BIOELECTRONICS, 2004 Apr. 15; 19(9):1013-9. In addition, macroporous silicon can be used as an electrical sensor for real time, label free detection of DNA hybridization whereby electrical contact is made exclusively on a back side of a substrate to allow complete exposure of a porous layer to DNA. Hybridization of a DNA probe with its complementary sequence produces a reduction in the impedance and a shift in the phase angle resulting from a change in dielectric constant inside the porous matrix and a modification of a depletion layer width in the crystalline silicon structure. Again, the effect of the DNA charge on the response can be corroborated using peptide nucleic acid (PNA), which is an uncharged analog of DNA. Single Nucleotide Polymorphism (“SNP”).

The diagnostic kit, microarray or probes or nucleotides immobilized on a substrate or surface, and any of the methods for detecting an SNP described above can contain or be provided with a limited number of probes. Probes include, but are not limited to, nucleotides that hybridize with the locus of a SNP or a primer that binds to a flanking region relative to the locus of the SNP to assist in determining the identity of the SNP by Sanger sequencing or similar technique.

In certain embodiments, the limited number of probes is from about 1 to about 50 probes. In other embodiments, the limited number of probes is less than about 10 probes, or any of less than about 100, less than about 50, less than about 30 probes or less than about 10 probes. In some embodiments, the limited number of probes is any of from about 2 to about 100 probes, from about 2 to about 50, from 2 to about 30 probes, and from 2 to about 6 probes.

### Methods for Detecting a Polymorphism

Generally, genetic variations are associated with human phenotypic diversity and sometimes disease susceptibility. As a result, variations in genes may prove useful as markers for disease or other disorder or condition. Variation at a particular genomic location is due to a mutation event in the conserved human genome sequence, leading to two or more possible nucleotide variants at that genetic locus. If both nucleotide variants are found in at least 1% of the population, that location is defined as a Single Nucleotide Polymorphism (“SNP”). Moreover, SNPs in close proximity to one another are often inherited together in blocks called haplotypes. One phenomenon of SNPs is that they can undergo linkage disequilibrium, which refers to the tendency of specific alleles at different genomic locations to occur together more frequently than would be expected by random change. Alleles at given loci are said to be in complete equilibrium if the frequency of any particular set of alleles (or haplotype) is the product of their individual population frequencies. Several statistical measures can be used to quantify this relationship. Devlin and Risch, A comparison of linkage disequilibrium measures for fine-scale mapping, GENOMICS, 1995 Sep. 20; 29(2):311-22.

An allele found to have a higher than expected prevalence among individuals positive for a given outcome is considered a “risk allele” for that outcome. An allele that is found to have a lower than expected prevalence among individuals positive for an outcome is considered a “protective allele” for that outcome. But while the human genome harbors 10 million “common” SNPs, minor alleles indicative of heart disease are often only shared by as little as one percent of a population.

Hence, as provided herein, certain SNPs found by one or a combination of these methods have been determined to be useful as genetic markers for risk-stratification of SCD or SCA in individuals. Further, certain SNPs found by one or a combination of these methods can be useful as genetic markers for identifying subjects who are prone to SCA that would benefit from treatment using ICDs. Genome-wide association studies are used to identify disease susceptibility genes for common diseases and involve scanning thousands of samples, either as case-control cohorts or in family trios, utilizing hundreds of thousands of SNP markers located throughout the human genome. Algorithms can then be applied that compare the frequencies of single SNP alleles, genotypes, or multi-marker haplotypes between disease and control cohorts. Regions (loci) with statistically significant differences in allele or genotype frequencies between cases and controls, pointing to their role in disease, are then analyzed. For example, following the completion of a whole genome analysis of patient samples, SNPs for use as clinical markers can be identified by any, or combination, of the following three methods:

(1) Statistical SNP Selection Method: Univariate or multivariate analysis of the data is carried out to determine the correlation between the SNPs and the study outcome, life threatening arrhythmias for the present invention. SNPs that yield low p-values are considered as markers. These techniques can be expanded by the use of other statistical methods such as linear regression.

(2) Logical SNP Selection Method: Clustering algorithms are used to segregate the SNP markers into categories which would ultimately correlate with the patient outcomes. Classification and Regression Tree (“CART”) is one of the clustering algorithms that can be used. In that case, SNPs forming the branching nodes of the tree will be the markers of interest.

(3) Biological SNP Selection Method: SNP markers are chosen based on the biological effect of the SNP, as it might affect the function of various proteins. For example, a SNP located on a transcribed or a regulatory portion of a gene that is involved in ion channel formation would be a good candidate. Similarly, a group of SNPs that are shown to be located closely on the genome would also hint the importance of the region and would constitute a set of markers.

An explanation of an rs number and the National Center for Biotechnology Information (NCBI) SNP database is provided herein. In collaboration with the National Human Genome Research Institute, The National Center for Biotechnology Information has established the Single Nucleotide Polymorphism Database (dbSNP) database to serve as a central repository for both single base nucleotide substitutions, also known as single nucleotide polymorphisms (SNP) and short deletion and insertion polymorphisms. Reference Sequences, or RefSeqs (rs), are a curated, non-redundant set of records for mRNAs, proteins, contigs, and gene regions constructed from a GenBank exemplar for that protein or sequence. The rs numbers represent a unique record for a SNP. Submitted SNPs (ss) are records that are independently submitted to NCBI, are used to construct the rs record, and are cross-referenced with the rs record for the corresponding genome location. Submitter-Referenced Accession numbers are annotations that are included with a SS number. For rs records relevant to the present invention, these accession numbers may be associated with a GenBank accession record, which will start with one or two letters, such as “AL” or “AC,” followed by five or six numbers. The NCBI RefSeq database accession numbers have different formatting: “NT_{—}123456.” The RefSeq accession numbers are unique identifiers for a sequence, and when minor changes are made to a sequence, a new version number is assigned, such as “NT_{—}123456.1,” where the version is represented by the number after the decimal. The rs number represents a specific range of bases at a certain contig position. Although the contig location of the rs sequence may move relative to the length of the larger sequence encompassed by the accession number, that sequence of bases represented by the rs number, i.e., the SNP, will remain constant. Hence, it is understood that rs numbers can be used to uniquely identify a SNP and fully enables one of ordinary skill in the art to make and use the invention using rs numbers. The sequences provided in the Sequence Listing each correspond to a unique sequence represented by an rs number known at the time of invention. Thus, the SEQ ID Nos. and the rs numbers claimed disclosed herein are understood to represent uniquely identified sequences for identified SNPs and may be used interchangeably.

Genetic markers are non-invasive, cost-effective and conducive to mass screening of individuals. The SNPs identified herein can be effectively used alone or in combination with other SNPs as well as with other clinical markers for risk-stratification, assessment, and diagnosis susceptibility to SCA that can be treated with an ICD. The genetic markers taught herein provide greater specificity and sensitivity in identification of individuals that could benefit from receiving an ICD to prevent death resulting from SCA. Sudden Cardiac Arrest (“SCA”)

Sudden Cardiac Arrest (“SCA”), also known as Sudden Cardiac Death (“SCD”), results from an abrupt loss of heart function. It is commonly brought on by an abnormal heart rhythm. SCD occurs within a short time period, which is generally less than an hour from the onset of symptoms. Despite recent progress in the management of cardiovascular disorders generally, and cardiac arrhythmias in particular, SCA remains a problem for the practicing clinician as well as a major public health issue.

In the United States, SCA accounts for the loss of over 300,000 individuals each year. More deaths are attributable to SCA than to lung cancer, breast cancer, or AIDS. This represents an incidence of 0.1-0.2% per year in the adult population. Myerburg, R J et al., Cardiac arrest and sudden cardiac death, Braunwald E, ed., A TEXTBOOK OF CARDIOVASCULAR MEDICINE. 6^{TH} ED., Philadelphia, Saunders, W B., 2001; 890-931; American Cancer Society, Cancer Facts and Figures 2003; 4; Center for Disease Control 2004.

In approximately 80% of cases, SCA occurs in the setting of Coronary Artery Disease (“CAD”). Most instances involve Ventricular Tachycardia (“VT”) degenerating to Ventricular Fibrillation (“VF”) and subsequent asystole. Fibrillation occurs when transient neural triggers impinge upon an unstable heart causing normally organized electrical activity in the heart to become disorganized and chaotic. Complete cardiac dysfunction results. Non-ischemic cardiomyopathy and infiltrative, inflammatory, and acquired valvular diseases account for most other SCA, or SCD, events. A small percentage of sudden cardiac arrest events occur in the setting of ion channel mutations responsible for inherited abnormalities such as the long/short QT syndromes, Brugada syndrome, and catecholaminergic ventricular tachycardia. These conditions account for a small number of events. In addition, other genetic abnormalities such as hypertrophic cardiomyopathy and congenital heart defects such as anomalous coronary arteries are responsible for SCA.

To identify genetic markers associated with SCA or SCD, a sub-study (also referred to herein as “MAPP”) to an ongoing clinical trial (also referred to herein as “MASTER”) was designed and implemented. The MASTER study was undertaken to determine the utility of T-wave-alternans test for the prediction of SCA in patients who have had a heart attack and are in heart failure. The data collected from the patients participating in the MAPP study were retrospectively analyzed to search for genetic markers that may be associated with patients being unresponsive to anti-arrhythmic medications. The MAPP study was a prospective study of 240 patients who had an ICD implanted at enrollment, with a 2.6 year mean follow-up period. Based on the arrhythmic events that the patients had during this follow-up, they were categorized in three groups as shown in Table 2.

TABLE 2
Outcome of MAPP Patients

| Patient Category | Number |
|---|---|
| CASE 1—Life Threatening Left Ventricular Event | 33 |
| CASE 2—Non-life Threatening Left Ventricular Events | 2 |
| CONTROL—No Events | 205 |
| Total | 240 |

Table 3 provides a brief summary of the demographic and physiologic variables that were recorded at the time of enrollment. Except for the Ejection Fraction (“EF”), none of the variables were found to be predictive of the patient outcome, as shown by the large p-values in Table 3. Although the EF gave a p-value less than 0.05, indicating a correlation with the presence of arrhythmic events, it did not provide a sufficient separation of the two groups to act as a prognostic predictor for individual patients, which in turn further confirmed the initial assessment that there is no strong predictor for SCA.

TABLE 3
Demographic and Physiologic Variable Summary
For the MAPP Patient Population

| Variable | Entire MAPP | | Case 1 | | Control | | |
|---|---|---|---|---|---|---|---|
| Name | N = 240 | | N = 33 | | N = 205 | | p-value |
| | Mean (SD) | | | | | | |
| Age (years) | 63.2 | (11.0) | 61.6 | (8.5) | 63.5 | (11.3) | 0.3694 |
| EF (%) | 27.1 | (6.5) | 25.0 | (6.3) | 27.5 | (6.4) | 0.0449 |
| NYHA Class | 2.7 | (1.4) | 2.9 | (1.4) | 2.7 | (1.4) | 0.4015 |
| QRS Width | 115.4 | (29.8) | 115.0 | (23.8) | 115.5 | (30.7) | 0.9443 |
| (msec) | | | | | | | |
| | N (%) | | | | | | |
| Sex (Male) | 209 | (87.1) | 26 | (78.8) | 183 | (88.4) | 0.1582 |
| MTWA | 77 | (32.2) | 13 | (39.4) | 64 | (31.0) | 0.4223 |
| (Negative) | | | | | | | |
| Race | 224 | (93.3) | 31 | (93.9) | 193 | (93.2) | 1 |
| (Caucasian) | | | | | | | |

(EF: Ejection fraction; NYHC: New York Heart Class; MTWA: Microvolt T-Wave Alternans test)

Association of genetic variation and disease can be a function of many factors, including, but not limited to, the frequency of the risk allele or genotype, the relative risk conferred by the disease-associated allele or genotype, the correlation between the genotyped marker and the risk allele, sample size, disease prevalence, and genetic heterogeneity of the sample population. In order to search for associations between SNPs and patient outcomes, genomic DNA was isolated from the blood samples collected from the 240 patients who participated in this study. Following the DNA isolation, a whole genome scan consisting of 317,503 SNPs was conducted using Illumina 300K HapMap gene chips. For each locus, two nucleic acid reads were done from each patient, representing the nucleotide variants on two chromosomes, except for the loci chromosomes on male patients. Four letter symbols were used to represent the nucleotides that were read: cytosine (C), guanine (G), adenine (A), and thymine (T). The structure of the various alleles is described by any one of the nucleotide symbols of Table 1.

Following the compilation of the genetic data into an electronic database, statistical analysis was carried out. Results from this analysis and all SNP sequence information, including rs numbers and FASTA sequences are as described in U.S. Patent App. Pub. 2009/0136954 and U.S. Patent App. Pub. 2009/0131276, each of which is incorporated herein by reference.

In general, multiple family studies have emphasized genetic factors as a prominent risk factor for SCA and SCD, with relative risks of 1.5 to 2.7 in case-control studies among first-degree relatives who have died suddenly. In particular, several studies have recently identified specific gene variants or genome loci that are associated with SCA or SCD. These include variants in cardiac ion channel genes KCNQ1 and SCN5A, nitric oxide synthase 1 adaptor protein, and a susceptibility locus at 21q21 for ventricular fibrillation (VF) in patients who have had acute myocardial infarction (MI). Moreover, common variants in at least 10 genomic loci have been correlated with the QT duration, a key indicator of cardiac repolarization. Pfeufer et al., Common Variants at Ten Loci Modulate the QT Interval Duration in the QTSCD Study, NATURE GENETICS, 2009; 41:407-414.

Although considerable research has been directed to identifying the genomics of life threatening arrhythmias, there has not yet been a genome-wide assessment of patients who have received an ICD. ICDs are implanted in approximately 250,000 individuals in the United States each year for criteria that include diminished ejection fraction (EF), symptomatic heart failure, and, to a lesser extent, prolongation of the QRS interval or other electrophysiologic markers such as microvolt T-wave alternans or late potential on signal-averaged electrocardiograms. Although ICDs have a success rate of more than 97% for sensing and terminating life threatening arrhythmias, ICDs are not activated in approximately 90% of patients for the duration of their lives. Accordingly, the current criteria for selecting patients are rather crude, particularly when one considers that the ICDs are expensive devices that cost approximately $30,000 and are associated with various complications, including infection, lead failures, device malfunctions, and inappropriate shocks.

A study involving a genome-wide assessment of patients who had an ICD implant was designed and implemented (also referred to herein as “GAME”: Genetic Arrhythmia Markers for Early Detection). This study was undertaken to determine whether common DNA sequence variants associated with life threatening arrhythmia (LTA) existed for the purposes of refining patient selection for ICD use. Thus, the information obtained from the study was used to identify the patients in the study population having a need for an ICD. This information can be extrapolated to those individuals at risk in the general population who do not meet current clinical criteria for consideration of ICD therapy for primary prevention of LTA.

The GAME patient dataset was analyzed using a total of 904 Caucasian patients, of which 607 patients were identified as Case subjects and 297 were identified as Control subjects. A 0.2 mL aliquot of whole blood obtained from each patient was used for DNA isolation using the Qiagen QIAmp DNA Mini Kit (Qiagen, Valencia, Calif.; Catalog #51185) and QiaCube Robotic workstation for automated DNA purification. The typical yield was 2-10 μg DNA from 0.2 mL blood. DNA was “quanted” using a nanodrop spectrophotometer, and DNA concentrations were adjusted to 50 ng/μL.

DNA obtained from the patient cohort was processed using the Illumina 660W BeadChip to extract genotype data on approximately 660,000 SNPs from each patient. Genotyping was performed according to the manufacturer's instructions. After each batch, genotypes were called using the provided Illumina cluster file, and the individual sample rates were inspected. Samples with less than 99% call rates were re-genotyped. After all samples were genotyped, the genotypes were clustered within GenomeStudio using all samples with greater than 98% call rates. Samples with call rates of less than 99%, SNPs with call rates less than 95%, and heterozygote frequencies of greater than 65% after re-clustering were removed. Autosomal SNPs with cluster separation scores of less than or equal to 0.30 and X-chromosome SNPs with cluster separation scores of less than or equal to 0.38 were removed. Sample call rates were then recalculated, and individuals with call rates less than 99% were removed, resulting in a median call rate of 99.989%. Concordance was calculated based on 12 duplicate samples (99.998%). Duplicate samples were retained based on fiftieth percentile Illumina GenCall GC Scores. At this stage in quality control, 1021 samples had been retained.

Additional QC was undertaken in PLINK (Purcell S., PLINK (1.07), available at http://pngu.mgh.harvard.edu/purcell/plink/; Purcell et al., PLINK: A Toolset For Whole-Genome Association and Population-Based Linkage Analysis, AM. J. OF HUMAN GENETICS, 2007; 81). Patients were tested for gender consistency, cryptic relatedness, and ancestry. Gender consistency was tested using the—check-sex command in PLINK, and individuals that disagreed with their reported gender, when applicable, were removed. There were three samples with genders that disagreed with their reported gender. Upon further data review, this error was determined to have originated in the clinical data charts, and the three samples were added back into the final genotype dataset. Cryptic relatedness was tested using the—genome command, which was run on SNPs that had been filtered for linkage equilibrium (N=105,837, —indep-pairwise 50 5 0.5). Based on the proportion of relatedness (PI_HAT), three pairs of samples were duplicate or twin samples (PI_HAT ˜1) and one pair of siblings (PI_HAT ˜0.5) were present. Additional samples were removed based on the presence of phenotype data. Samples were clustered by multidimensional scaling with HapMap3 samples using SNPs in linkage equilibrium. There were four samples that clustered outside the European (CEU and TSI) ancestry groups and were removed. This resulted in a total of 1,009 samples, with 605 Case subjects, 296 Control subjects, and 108 samples with missing phenotype status.

SNPs were additionally filtered for minor allele frequency (>0.01 in all samples) and Hardy-Weinberg equilibrium (p<10⁻⁶ in Control samples). SNPs were updated to genome forward orientation using the Human660W-Quad_v1_A.c svb129_SNPChrPosOnRef_{—}36_{—}3.bcp files. These are files built by Illumina that contain information on SNP orientation. If a SNP was not present in the NCBI dbSNP or did not map uniquely to the reference genome, then they were not used in the data analysis (N=645). SNPs are occasionally removed from NCBI dbSNP for a variety of reasons. For example, an SNP record may be a duplicate, or artifact. In this case, there were 645 SNPs deleted from the dbSNP database after the Illumina chip was designed. Thus, these SNPs were not used in the data analysis because they were assumed to be obsolete. However, records for removed SNPs can be located in dbSNP.

In the study, approximately 660,000 SNPs from each patient were analyzed using the gene chip as previously described. However, it is known that the human genome contains many more SNPs than the 660,000 SNPs that are read by gene chips. Using the haplotype data available from public databases and the actual SNP data obtained from the patients, the genotypes can be imputed at SNP locations where the genotype was not read. This can be accomplished using the MACH haplotyper program (MACH 1.0, Gonçalo Abecasis and Yun Li), which takes advantage of a statistical technique known as Hidden Markov Model (HMM). MACH 1.0 is a Markov Chain based haplotyper that can resolve long haplotypes or infer missing genotypes in samples of unrelated individuals. MACH input files include information on experimental genotypes for a set of individuals and, optionally, on a set of known haplotypes. MACH can use estimated haplotypes for each sampled individual (conditional on the observed genotypes) or fill in missing genotypes (conditional on observed genotypes at flanking markers and on the observed genotypes at other individuals). The essential inputs for MACH are a set of observed genotypes for each individual being studied. Typically, MACH expects that all the markers being examined map to one chromosome and that appear in map order in the input files. These requirements can be relaxed when using phased haplotypes as input. MACH also expects observed genotype data to be stored in a set of matched pedigree and data files. The two files are intrinsically linked, the data file describes the contents of the pedigree file (every pedigree file is slightly different), and the pedigree file itself can only be decoded with its companion data file. The two files can use either the Merlin/QTDT or the LINKAGE format. Data files can describe a variety of fields, including disease status information, quantitative traits and covariates, and marker genotypes. A simple MACH data file simply lists names for a series of genetic markers. Each marker name appears its own line prefaced by an “M” field code. The genotypes are stored in a pedigree file. The pedigree file encodes one individual per row. Each row should start with a family ID and individual ID, followed by a father and mother ID (which typically are both set to 0, “zero,” since the current version of MACH assumes all sampled individuals are unrelated), and sex. These initial columns are followed by a series of marker genotypes, each with two alleles. Alleles can be coded as 1, 2, 3, 4 or A, C, G, T. For many analyses, but in particular for genotype imputation, it can be very helpful to provide a set of reference haplotypes as input. Reference haplotypes can include genotypes for markers that were not examined in the examined data set, e.g., GAME or MAPP, but that can frequently be imputed based on genotypes at flanking markers. Most commonly, these haplotypes are derived from a public resource such as the International HapMap Project and will be derived, eventually, from the 1000 Genomes Project.

In the present invention, the phased HapMap format haplotypes were obtained from http://hapmap.ncbi.nlm.nih.gov/downloads/phasing/2007-08_rel22/phased/ as the reference information and training set. These data provide the nucleotide at each SNP site genotyped in phase, i.e., both copies of each chromosome are individually sequenced, so that the haplotype structure for each chromosome is clear. The phased data is comprised of rs numbers and nucleotide variants, so it does account for the genetic structure. The data set to be imputed in the present invention is the genotype chip data, which is unphased, meaning that it is not clear on which of the two chromosomes each variant of a heterozygous genotype occurs. Hence, part of the purpose for HMM modeling is determining which of the two chromosomes each variant of a heterozygous genotype occurs. Moreover, HMM modeling explores where haplotype breaks are probable and uses the breaks for imputation prediction.

Hidden Markov Models work on the assumption that there is a stochastic relationship between the internal, and usually unobservable, states of a system. Moreover, the assumption is such that the internal states of the system can be determined by the observation of its output. For purposes of the invention, the unknown internal states include the entire genome of the patient, and the observed states include SNP locations that are read with the gene chips. This is explained further in the following example.

The use of Markov Models will be illustrated with a simple example to determine a nucleotide based on its neighbors to the right and left side in the genome, based upon some a priori knowledge.

To a first approximation, the successive bases known to conform to the transition matrix shown in Table 4.

TABLE 4
Transition Matrix For Genetic Bases During A Walk In 5′
To 3′ Direction: . . . X, Y, Z, . . .

| | Probability of Next Nucleotide(Y) | | | | |
|---|---|---|---|---|---|
| | | A | C | G | T |
| Given the | A | 0.32 | 0.18 | 0.23 | 0.27 |
| Present | C | 0.37 | 0.23 | 0.05 | 0.35 |
| Nucleotide | G | 0.30 | 0.21 | 0.25 | 0.24 |
| in the | T | 0.23 | 0.19 | 0.25 | 0.33 |
| Genome (X) | | | | | |

The matrix shown in Table 4 is interpreted as follows: If there is a “G” in the current location (X) in the genome, then the likelihood of having an “A,” “C,” “G,” or “T” in the next nucleotide location (Y) is 0.30, 0.21, 0.25, and 0.24, respectively, as is shown in the second row from the bottom. In mathematical terms, this is described by the following equation:

P(Y=A|X=G)=0.30 (Eq. 1)

It is assumed that nucleotides X, Y, and Z are located in a series. If a “G” is read as SNP location X using a gene chip, then the next nucleotide in the 3′ direction, i.e., Y, is most likely to be an “A,” based on the data shown in Table 1. This 30% probability can be further improved if the nucleotide at the next following location, Z, is also known. If it is known that there is a “T” at location Z, then the expected value of Y can be calculated using the Bayes' Theorem (Devore, PROBABILITY & STATISTICS FOR ENGINEERING & THE PHYSICAL SCIENCES, Brooks/Cole Pub. Co., Monterey, Calif., 1982, p. 54, ISBN: 0-8185-0514-1):

$$P ( Y \vert Z ) = \frac{P ( Z \vert Y ) P ( Y )}{P ( Z )} \qquad ( Eq . 2 )$$

From the study, approximate values for the frequency of A, T, C and G in the genome are known, as follows: P(A)=P(T)=30% and P(C)=P(G)=20%. Given that Z=T, the individual expected values for the four nucleotides at position Y are calculated as follows:

$$\begin{matrix}P ( Y = A \vert Z = T ) = P ( Z = T \vert Y = A ) \cdot \frac{P ( A )}{P ( T )} = 0.27 \cdot \frac{0.30}{0.30} = 0.27 & ( Eq . 5 ) \\ P ( Y = C \vert Z = T ) = P ( Z = T \vert Y = C ) \cdot \frac{P ( C )}{P ( T )} = 0.35 \cdot \frac{0.20}{0.30} = 0.23 & ( Eq . 6 ) \\ P ( Y = G \vert Z = T ) = P ( Z = T \vert Y = G ) \cdot \frac{P ( G )}{P ( T )} = 0.24 \cdot \frac{.20}{0.30} = 0.16 & ( Eq . 7 ) \\ P ( Y = T \vert Z = T ) = P ( Z = T \vert Y = T ) \cdot \frac{P ( T )}{P ( T )} = 0.33 \cdot \frac{0. .30}{0.30} = 0.33 & ( Eq . 8 )\end{matrix}$$

Based on these calculations, one can conclude that if Z=T, then Y is most likely to be a T, because the probability of P(Y=A|Z=T) resulted in the largest value of 0.33. These conclusions are in accord with the data in the last row of Table 5. Therefore, the nucleotide at location Y is most likely to be a T.

As more correlations are used, the reliability of the prediction increases. It is necessary to construct the transition matrix, as learned from the Human Genome Project, as shown in Table 4 to determine the correlations between the unknown parameters, such as Y, and the observed parameters, such as X and Z. The generic imputation process requires that these correlations be determined ahead of time. This may be accomplished using the existing reference data from the International HapMap Project. The observed parameters would then be the SNP locations read by the gene chips, such as the nucleotides corresponding to X and Z in the preceding example, and the unknown parameters would be the untyped genome locations, such as the nucleotide at location Yin the preceding example.

In the GAME study, the Hidden Markov Model was used as follows: The DNA samples were processed with the Illumina 660W BeadChip, as previously described, to extract data on approximately 660,000 SNPs from each patient. Genotypic imputations were performed to determine the SNPs for all HapMap (phase II, release 22) SNPs using the MACH algorithm. As previously described, the MACH algorithm uses the Hidden Markov Model to impute the un-typed SNPs. The CEU HapMap phased haplotypes were used as a reference consisting of N=60 unrelated individuals. The best estimate of the quantitative allele dosage was used as the predictor in association tests. Six SNP markers gave results, as indicated by their p-values: rs6565373 (SEQ ID No. 4), rs11856574 (SEQ ID No. 1), rs482329 (SEQ ID No. 3), rs3848198 (SEQ ID No. 3), rs592197 (SEQ ID No. 5), and rs556186 (SEQ ID No. 6). SNPs rs592197 (SEQ ID No. 5), and rs556186 (SEQ ID No. 6) are on chromosome 1, and both are <2 Kb from rs482329 (SEQ ID No. 2). These two SNPs are also in the same haplotype as rs482329 (SEQ ID No. 2). All six markers are shown in Table 5 and Table 7.

Specifically, Table 5 shows the SNPs that were found to be statistically relevant by the analysis of the GAME study dataset, which contained 607 Case subjects and 297 Control subjects.

TABLE 5

| | | | | | | P-values | |
|---|---|---|---|---|---|---|---|
| | Alleles | | Pos | Freq | OR | imputed | Nearest gene, description, |
| Top SNP | (A1/A2) | Chr | (GRCh37) | (A1) | (A1) | from GAME | relative SNP location |
| rs11856574 | G/A | 15 | 29731444 | 0.86 | 2.02 | 5.0 × 10⁻⁶ | KIAA0574, hypothetical protein, |
| | | | | | | | intron |
| rs482329 | C/G | 1 | 234816554 | 0.61 | 1.60 | 5.5 × 10⁻⁶ | IRF2BP2, interferon regulatory |
| | | | | | | | factor 2 binding protein 2, 72 kb |
| | | | | | | | downstream |
| rs592197 | C/G | 1 | 234817283 | 0.644 | 1.60 | 4.0 × 10⁻⁶ | IRF2BP2, interferon regulatory |
| | | | | | | | factor 2 binding protein 2, 72 kb |
| | | | | | | | downstream |
| rs556186 | C/G | 1 | 234814884 | 0.633 | 1.59 | 5.3 × 10⁻⁶ | IRF2BP2, interferon regulatory |
| | | | | | | | factor 2 binding protein 2, 72 kb |
| | | | | | | | downstream |
| rs3848198 | C/T | 15 | 80639564 | 0.32 | 1.81 | 9.8 × 10⁻⁶ | ARNT2, Aryl hydrocarbon |
| | | | | | | | receptor nuclear translocator 2; |
| | | | | | | | hypoxia associated transcription |
| | | | | | | | factor, 57 kb upstream |
| rs6565373 | T/C | 16 | 88260042 | 0.59 | 0.32 | 9.8 × 10⁻⁶ | BANP, BTG3 associated nuclear |
| | | | | | | | protein isoform a; negative |
| | | | | | | | regulator of p53 transcription, |
| | | | | | | | 149 kb downstream |

The FASTA sequences for six SNPs are shown in Table 6, which provides the major allele and its frequency within the CEU HapMap population. A positive orientation indicates a sequence from the 5′ to 3′ direction and a negative orientation indicates a reverse complement of sequence read from the 3′ to 5′ direction.

TABLE 6

| | | Major | | |
|---|---|---|---|---|
| SNP | Sequence | Allele | Frequency | Orientation |
| rs11856474 | ggtaggggcagggaaagcatcagaat[A/G]taagatgaaccaggagcatcttata | G | 0.92 | Positive |
| (SEQ ID No. 1) | | | | |
| rs482329 | ggcggtgatggttgctactttttatg[C/G]agggtttttgaaggctctctcata | C | 0.64 | Positive |
| (SEQ ID No. 2) | | | | |
| rs3848198 | gttcaccagtaggggactggaaaaa[C/T]aaagttacatccatacaataaagcac | T | 0.63 | Negative |
| (SEQ ID No. 4) | | | | |
| rs6565373 | ggacccccaggatcgtcagggcctcc[C/T]acagctggagtgggaagggagcaga | T | 0.59 | Positive |
| (SEQ ID No. 4) | | | | |
| rs592197 | tgagttaaaaagagaagaggtagtg[C/G]ctggagaacgggaggcttgacgttga | G | 0.644 | Negative |
| (SEQ ID No. 5) | | | | |
| rs556186 | gtaacgaaagtttccactttttgcaa[C/G]ttaccatttatataaagtttaagac | G | 0.633 | Positive |
| (SEQ ID No. 6) | | | | |

Table 7 shows the p-values imputed for the SNPs using GAME study data with 603 Case subjects and 297 Control subjects. These SNPs were originally identified as markers as a result of the analysis of the GAME dataset.

TABLE 7
rs482329

| | Control | Case |
|---|---|---|
| GG | 66 | 74 |
| CG | 144 | 279 |
| CC | 87 | 254 |

p-value: 5.5 × 10

[symbol]

rs11856574

| | Control | Case |
|---|---|---|
| AA | 14 | 5 |
| AG | 82 | 115 |
| GG | 201 | 487 |

p-value: 5.0 × 10

[symbol]

rs3848198

| | Control | Case |
|---|---|---|
| CC | 23 | 86 |
| CT | 141 | 338 |
| TT | 133 | 183 |

p-value: 9.8 × 10

[symbol]

rs6565373

| | Control | Case |
|---|---|---|
| CC | 1 | 16 |
| CT | 246 | 529 |
| TT | 50 | 62 |

p-value: 9.8 × 10 [symbol] [symbol]
indicates data missing or illegible when filed

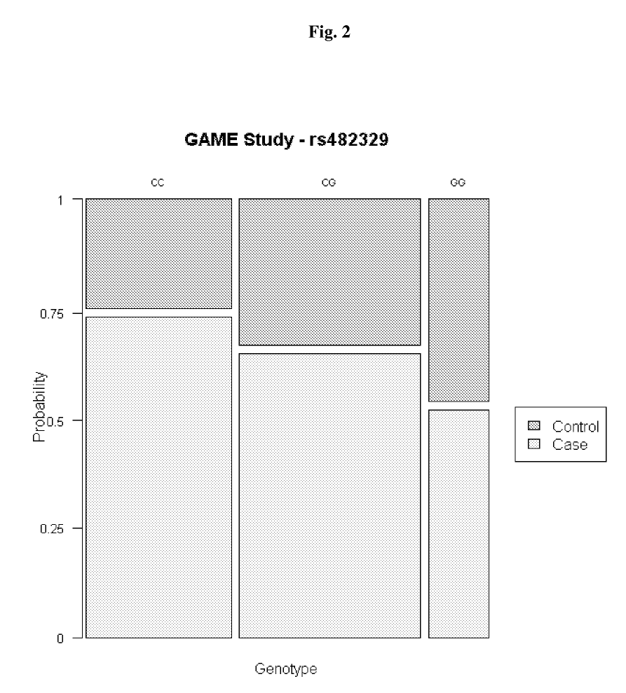

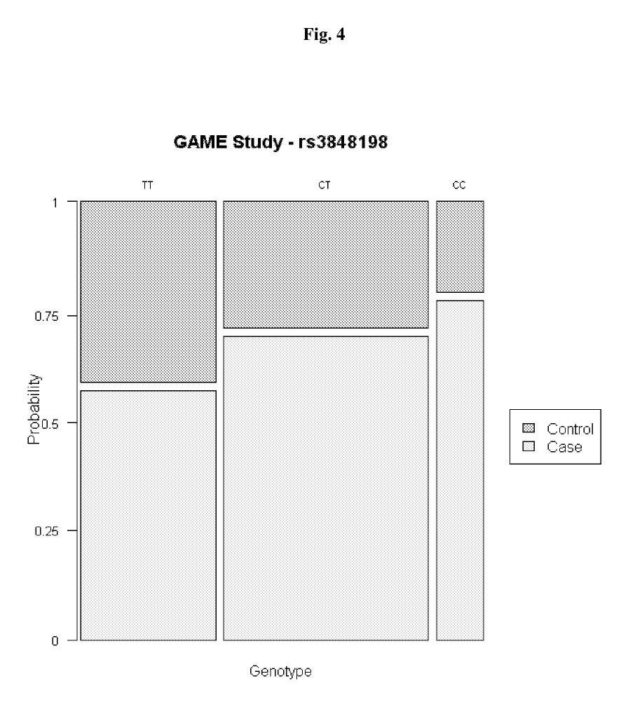

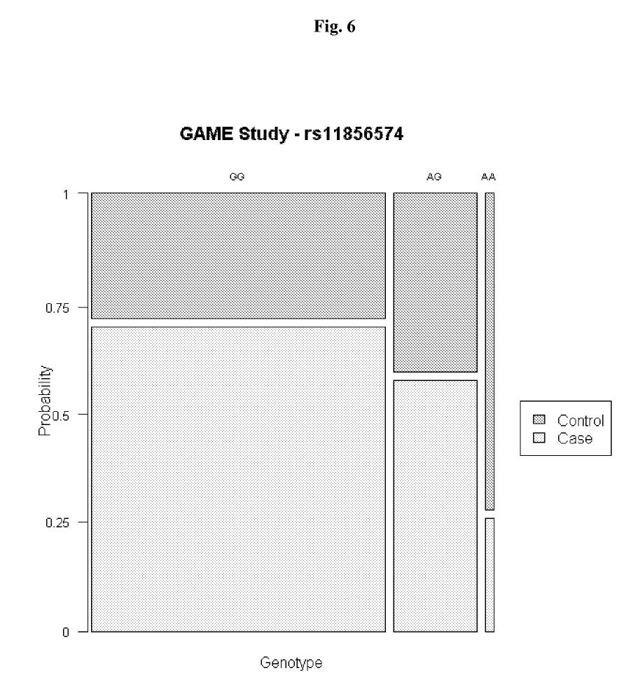

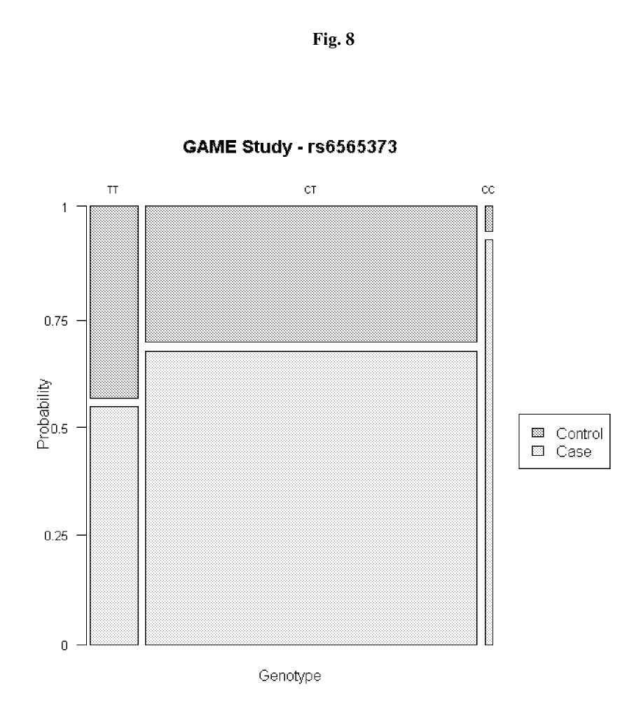

The data in Table 7 was used to calculate the probability of a subject experiencing life threatening arrhythmia or sudden cardiac arrest treatable with an ICD. The results are shown in the mosaic plots in FIGS. 2, 4, 6, and 8.

The SNPs were further tested in samples that were used in the MAPP study as described in U.S. patent application Ser. Nos. 12/271,338 and 12/271,385, the contents of which are incorporated herein by reference. The MAPP study data contained 33 Case subjects and 207 Control subjects. rs6565373 (SEQ ID No. 4) showed a low p-value of 0.02407. The results are shown in Table 8.

TABLE 8
rs482329

| | Control | Case | |
|---|---|---|---|
| CC | 82 | 16 | 0.163 |
| CG | 90 | 15 | 0.143 |
| GG | 35 | 2 | 0.054 |

p-value: 0.2716

rs11856574

| | Control | Case | |
|---|---|---|---|
| GG | 151 | 23 | 0.132 |
| AG | 50 | 10 | 0.167 |
| AA | 6 | 0 | 0.000 |

p-value: 0.6108

rs3848198

| | Control | Case | |
|---|---|---|---|
| TT | 73 | 7 | 0.088 |
| CT | 106 | 19 | 0.152 |
| CC | 28 | 7 | 0.200 |

p-value: 0.1913

rs6565373

| | Control | Case | |
|---|---|---|---|
| TT | 45 | 13 | 0.224 |
| CT | 157 | 18 | 0.103 |
| CC | 5 | 2 | 0.286 |

p-value: 0.02407

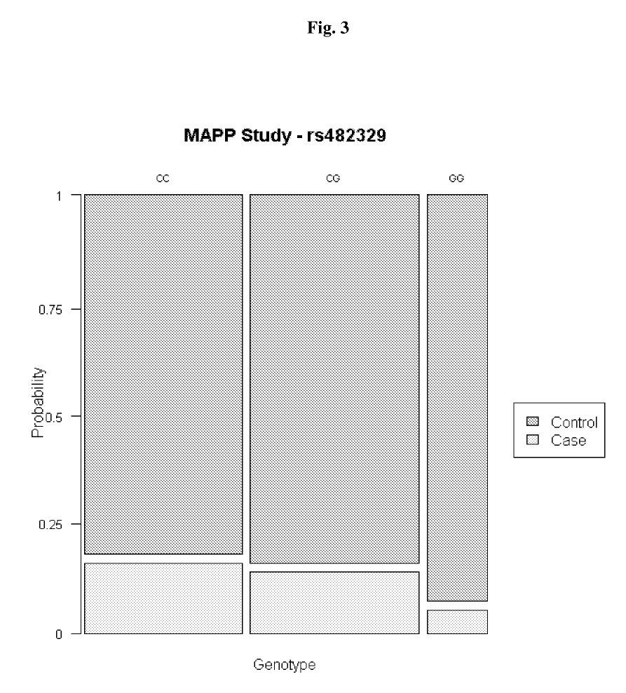

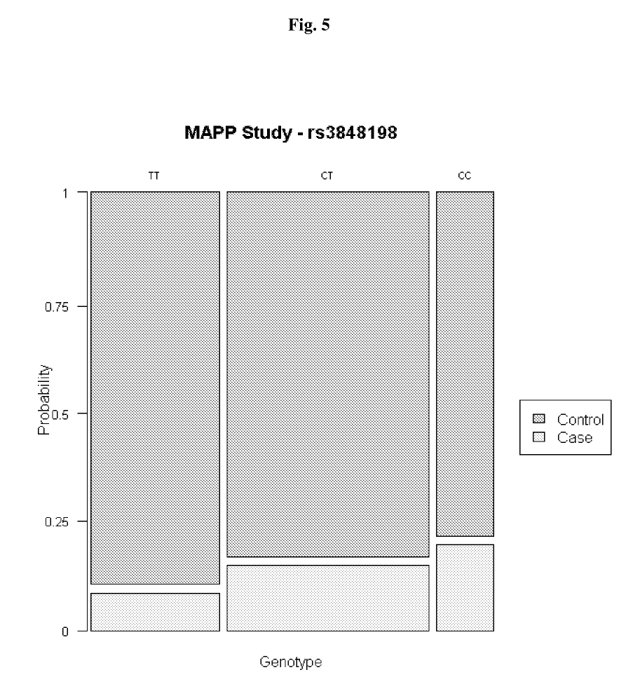

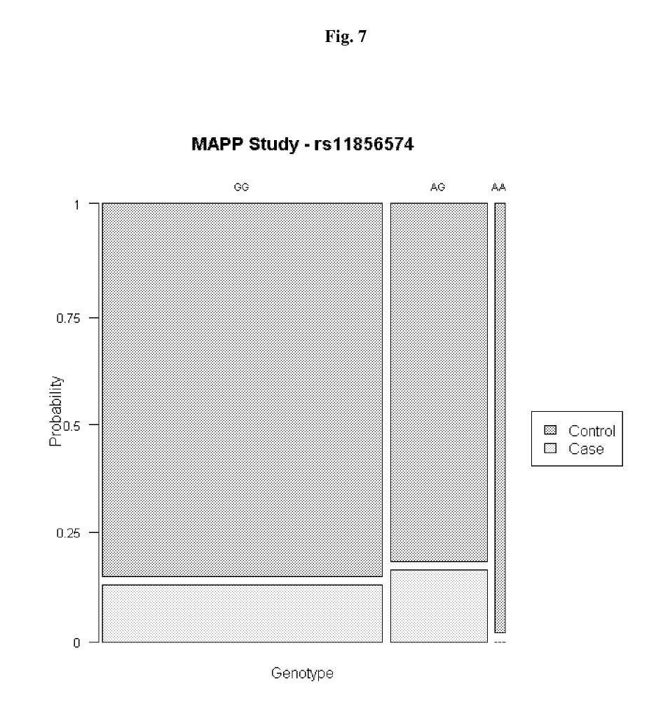

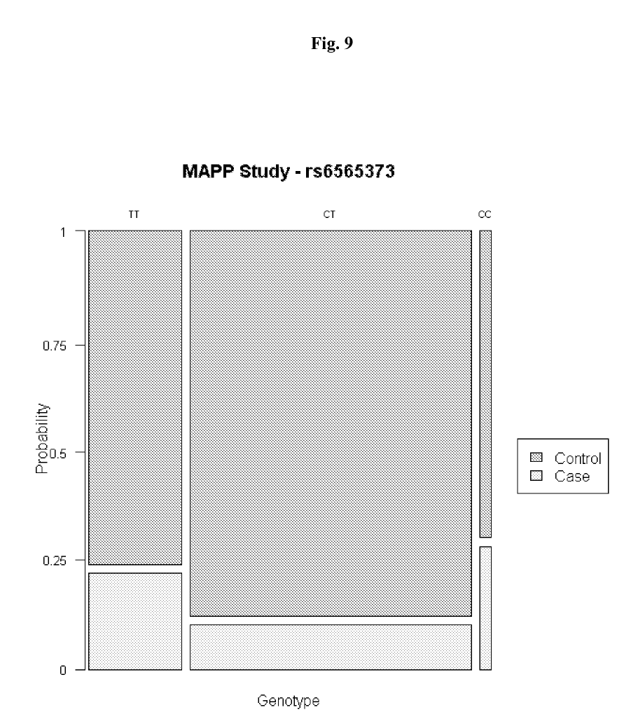

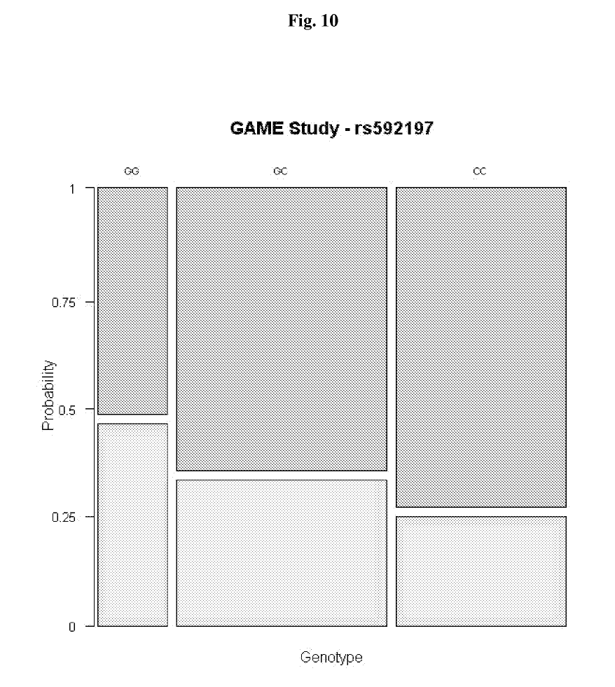

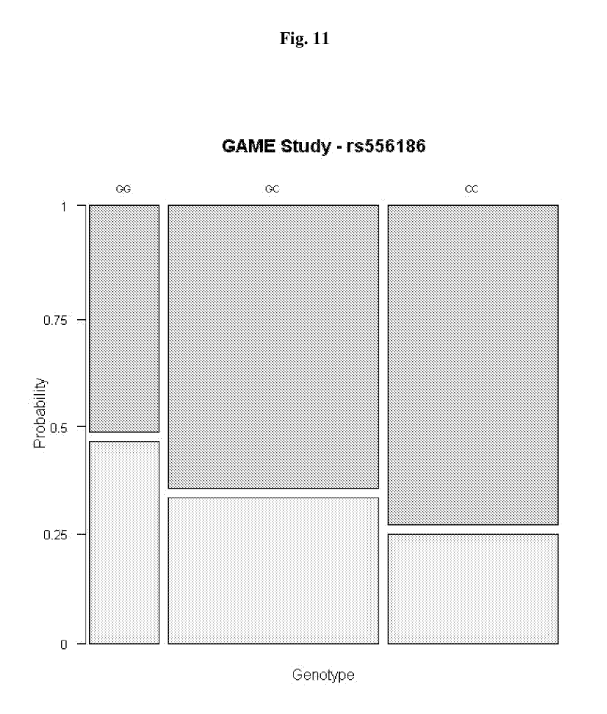

The data in Table 8 was also used to calculate the probability of a subject experiencing life threatening arrhythmia or sudden cardiac arrest. The results are shown in the mosaic plots in FIGS. 3, 5, 7, and 9. Comparison of the Figures shows that in the MAPP study, the subjects categorized as Control subjects generally had a high probability of experiencing a life threatening arrhythmia as compared to Case subjects, whereas the GAME study Control subjects had a relatively low probability of experiencing a life threatening arrhythmia as compared to Case subjects. In the MAPP study, the majority of the subjects are in the Control arm, whereas in the GAME study, the majority of the subjects are in the Case arm. This difference reflects the prospective study design for MAPP versus the retrospective subject recruitment in GAME.

Because the SNP marker, rs6565373 (SEQ ID No. 4), has shown significance in two independent studies, it is considered to be a significant marker and a predictor of SCA that can be treated and/or prevented with ICDs.

The GAME study also evaluated 42 SNPs that had previously been reported to implicate prolonged QT duration or sudden cardiac arrest. None were associated in the study dataset at Bonferroni corrected p-values (p<0.05/42=0.0012). Table 9 shows the p-values from directly genotyped or imputed genotypes for these 42 SNPs.

TABLE 9
Association at SNPs Previously Implicated in SCA,
Prolonged QT Duration, or Ventricular Fibrillation

| SNP | Gene/Region | A1/A2 | AF_A1 | OR | p-value |
|---|---|---|---|---|---|
| rs7692808 | ARHGAP24 | A/G | 0.29 | 0.98 | 0.833 |
| rs10919071 | ATP1B1 | A/G | 0.87 | 0.95 | 0.709 |
| rs7341478 | CACNA2D1 | A/G | 0.27 | 0.94 | 0.611 |
| rs3807989 | CAV1/CAV2 | A/G | 0.40 | 0.88 | 0.201 |
| rs37062 | CNOT1 | A/G | 0.76 | 0.90 | 0.380 |
| rs1733724 | DKK1 | G/A | 0.75 | 1.33 | 0.013 |
| rs6585682 | FGFR2 | C/T | 0.47 | 1.02 | 0.843 |
| rs3804999 | ITPR1 | A/G | 0.71 | 1.26 | 0.036 |
| rs1805128 | KCNE1 | C/T | 0.99 | 1.09 | 0.842 |
| rs2968863 | KCNH2 | C/T | 0.76 | 0.96 | 0.754 |
| rs2968864 | KCNH2 | T/C | 0.76 | 0.97 | 0.772 |
| rs17779747 | KCNJ2 | G/T | 0.67 | 0.92 | 0.445 |
| rs2282428 | KCNK1 | C/T | 0.35 | 0.95 | 0.646 |
| rs13376333 | KCNN3 | C/T | 0.69 | 0.92 | 0.452 |
| rs12576239 | KCNQ1 | C/T | 0.87 | 1.36 | 0.041 |
| rs12296050 | KCNQ1 | C/T | 0.82 | 1.27 | 0.065 |
| rs2074328 | KCNQ1 | C/T | 0.97 | 0.91 | 0.746 |
| rs2074518 | LIG3 | T/C | 0.49 | 1.07 | 0.495 |
| rs8049607 | LITAF | T/C | 0.49 | 0.94 | 0.539 |
| rs11897119 | MEIS1 | C/T | 0.40 | 1.04 | 0.676 |
| rs365990 | MYH6 | G/A | 0.37 | 1.02 | 0.853 |
| rs7188697 | NDRG4 | A/G | 0.75 | 0.94 | 0.614 |
| rs251253 | NKX2-5 | T/C | 0.62 | 1.03 | 0.826 |
| rs12029454 | NOS1AP | G/A | 0.85 | 1.08 | 0.575 |
| rs12143842 | NOS1AP | C/T | 0.76 | 1.06 | 0.599 |
| rs16857031 | NOS1AP | C/G | 0.87 | 0.97 | 0.844 |
| rs2200733 | PITX2 | C/T | 0.88 | 0.87 | 0.378 |
| rs6843082 | PITX2 | A/G | 0.78 | 0.95 | 0.698 |
| rs10033464 | PITX2 | G/T | 0.90 | 1.04 | 0.825 |
| rs11970286 | PLN | T/C | 0.45 | 0.95 | 0.597 |
| rs7146384 | QTC_14.1 | G/A | 0.67 | 1.20 | 0.070 |
| rs1559578 | QTC_5.3 | T/C | 0.65 | 1.05 | 0.649 |
| rs846111 | RNF207 | G/C | 0.72 | 0.97 | 0.844 |
| rs6795970 | SCN10A | A/G | 0.38 | 0.86 | 0.142 |
| rs11708996 | SCN5A | G/C | 0.85 | 0.82 | 0.181 |
| rs11129795 | SCN5A | G/A | 0.75 | 0.91 | 0.450 |
| rs12053903 | SCN5A | T/C | 0.66 | 1.07 | 0.520 |
| rs11047543 | SOX5 | G/A | 0.86 | 0.98 | 0.911 |
| rs13038095 | SULF2 | G/T | 0.90 | 0.98 | 0.929 |
| rs3825214 | TBX5 | A/G | 0.80 | 1.05 | 0.672 |
| rs1896312 | TBX5-TBX3 | T/C | 0.74 | 1.08 | 0.515 |
| rs4944092 | WNT11 | G/A | 0.32 | 1.11 | 0.334 |

It should be understood that the above-described embodiments and examples are merely illustrative of some of the many specific embodiments that represent the principles of the present invention. Numerous other versions can be readily devised by those skilled in the art without departing from the scope of the present invention.

1. A diagnostic kit for detecting one or more Single Nucleotide Polymorphisms (SNPs) associated with Sudden Cardiac Arrest (SCA), comprising a plurality of probes that are used for assessing the presence of said one or more SNPs in a genetic sample, said one or more SNPs being selected from a polymorphic position in any one of SEQ ID Nos. 1-6.

2. The diagnostic kit of claim 1, wherein the diagnostic kit comprises from about 2 to about 50 probes.

3. The diagnostic kit of claim 1, wherein the diagnostic kit comprises less than about 10 probes.

4. The diagnostic kit of claim 1, wherein at least one probe overlaps the polymorphic position in any one of SEQ ID Nos. 1-6, where the probe flanks the polymorphic position on either the 5′ and 3′ side by a single base pair to any number of base pairs flanking the 5′ and 3′ side of the polymorphic position sufficient to identify the SNP or result in a hybridization.

5. The diagnostic kit of claim 1, wherein the probe is a primer that binds to a sequence flanking the polymorphic position in any one of SEQ ID Nos. 1-6.

6. A system for detecting one or more Single Nucleotide Polymorphisms (SNPs) associated with Sudden Cardiac Arrest (SCA), comprising a computer system, having a computer processor programmed with an algorithm, and one or more genetic databases that are in communication with the programmed processor, wherein the programmed computer processor is used to impute an unobserved or untyped SNP based upon the observance of one or more typed SNPs detected in DNA contained in one or more genetic samples obtained from a patient and/or from the one or more genetic databases, wherein
susceptibility to SCA is determined at least in part based upon the one or more imputed SNPS.

7. The system of claim 6, wherein the p-value associated with susceptibility to SCA for the combination of the one or more imputed SNPs and the one or more typed SNPs is lower than the p-value associated with susceptibility to SCA for the one or more typed SNPs.

8. The system of claim 6, wherein a first typed SNP flanks an imputed SNP in a 5′ direction and a second typed SNP flanks the imputed SNP in a 3′ direction on the same chromosome.

9. The system of claim 6, wherein the one or more imputed SNPs and the one or more typed SNPs are located on the same chromosome and form part of the same haplotype.

10. The system of claim 6, wherein the at least one typed SNP is selected from a polymorphic position in any one of SEQ ID Nos. 2, 5 and 6 and optionally an SNP selected from a polymorphic position in any one of SEQ ID Nos. 1 and 3-4.

11. The system of claim 6, wherein at least one of the one or more SNPs is bi-allelic.

12. A method of evaluating susceptibility to Sudden Cardiac Arrest (SCA), comprising the steps of extracting genetic material from a biological sample obtained from a patient; analyzing for the presence of at least one Single Nucleotide Polymorphism (SNP) in a polymorphic position in one or more of SEQ ID Nos. 1-6 in the biological sample obtained; and assessing susceptibility to SCA based on the analysis.

13. The method of claim 12, further comprising:
determining the number of minor alleles in the biological sample, and
assessing susceptibility to SCA based on the step of determining the number of minor alleles to determine a risk score.

14. The method of claim 13, wherein the minor alleles are selected from the polymorphic position in any of SEQ ID Nos. 1-6.

15. The method of claim 12, wherein the biological sample is analyzed by combining the biological samples with one or more polynucleotide probes capable of hybridizing selectively, the hybridization overlapping the polymorphic position in one of SEQ ID Nos. 1-6.

16. The method of claim 12, further comprising the step of determining more than one SNP on the same chromosome at the polymorphic position in any one of SEQ ID Nos. 1-6.

17. The method of 12, wherein the biological sample is analyzed by combining the biological samples with oligonucleotides capable of priming polynucleotide synthesis in a polymerase chain reaction to amplify a polynucleotide containing the polymorphic position in any one of SEQ ID Nos. 1-6.

18. The method of claim 12, further comprising implanting an Implantable Cardioverted Defibrilator (ICD) in the patient based at least in part on analyzing for the presence of at least one SNP.

19. The method of claim 12, wherein an SNP allele of G at the polymorphic position of SEQ ID No. 2, an SNP allele of C at the polymorphic position of SEQ ID No. 3, an SNP allele of G at the polymorphic position of SEQ ID No. 1, an SNP allele of C at the polymorphic position of SEQ ID No. 4, an SNP allele of G at the polymorphic position of SEQ ID No. 5, or an SNP allele of G at the polymorphic position of SEQ ID No. 6 indicates susceptibility to SCA.

20. The method of claim 12, wherein at least one of the one or more SNPs is bi-allelic.
